(19) United States
(12) Patent Application Publication
(10) Pub. No.: US 2011/0024670 A1
(43) Pub. Date: Feb. 3, 2011

(54) COMPOSITE MAGNETIC MATERIAL AND METHOD OF MANUFACTURING THE SAME

(75) Inventors: Etsuo OTSUKI, Tokyo (JP); Ayako KANEDA, Tokyo (JP)

Correspondence Address: HARNESS, DICKEY & PIERCE, P.L.C., P.O. BOX 828, BLOOMFIELD HILLS, MI, 48303, US

(73) Assignee: TOHO ZINC CO., LTD., Tokyo (JP)

(21) Appl. No.: 12/903,496

(22) Filed: Oct. 13, 2010

Related U.S. Application Data
(63) Continuation of application No. PCT/JP2009/057450, filed on Apr. 13, 2009.

(30) Foreign Application Priority Data
Apr. 15, 2008 (JP) 2008-106046
Apr. 15, 2008 (JP) 2008-106047

(51) Int. Cl. H01F 1/06; B22F 7/04

(52) U.S. Cl. 252/62.54; 419/5

(57) ABSTRACT

Certain embodiments provide a composite magnetic material for an inductor, wherein a non-magnetic material contains a first binder as a compacting additive, and is added to and mixed with the soft magnetic metal powder, and a second binder that is impregnated to a compact as a binder after the heat treatment of the compact obtained by adding the first binder to the soft magnetic metal powder and compacting it, and the soft magnetic metal powder contains 40% by mass or more (including 100%) of spherical particles of which the ratio L2/L1 between a perimeter L1 of a particle cross-section in the two dimensional plane view and a perimeter L2 of a circle having equivalent cross-sectional area is 0.5 or more.

### CROSS REFERENCE TO RELATED APPLICATIONS

This is a Continuation Application of PCT Application No. PCT/JP2009/057450, filed Apr. 13, 2009, which was published under PCT Article 21(2) in Japanese.

This application is based upon and claims the benefit of priority from prior Japanese Patent Applications No. 2009-106046, filed Apr. 15, 2008; and No. 2008-106047, filed Apr. 15, 2008, the entire contents of both of which are incorporated herein by reference.

### BACKGROUND OF THE INVENTION

1. Field of the Invention

The present invention relates to an inductor that is wire-wound to a metal-based soft magnetic composite material that is applied to an electronic circuit such as a power circuit, particularly a composite magnetic material such as a dust core material used as a core that is excellent in magnetic properties, and a method for manufacturing the same.

2. Description of the Related Art

In recent years, along with needs for miniaturization and power-saving of electrical and electronic equipments, miniaturization and high efficiency of electronic components applied thereto are demanded. A ferrite has been conventionally often used as an inductor that is used in such circuit. However, due to low saturation magnetization of the ferrite resulting from low voltage and high current of the circuit, the ferrite is close cc limitation of its performance, and thus application of a material that has a high saturation magnetization is expected.

Conventionally, a dust core in which powders of a Fe—Si alloy and a Fe—Si—Al alloy are bonded to a non-magnetic material, has higher saturation magnetization than the ferrite, and is excellent in direct current superposition property, and thus has been used in an inductor core. However, these dust cores have more magnetic loss than the ferrite, and have not reached the level that they substitute the ferrite.

The dust core inductor is made by winding a conductive wire around a core compact that is compacted into a desired shape such as a toroidal form, and thus has been used as a noise suppression and smoothing function element of an electrical circuit, as described in, for example, Jpn. Pat. Appln. KOKAI Publication No. 2003-224019 (hereinafter, referred to as Patent Document 1) and Jpn. Pat. Appln. KOKAI Publication No. 11-233613 (hereinafter, referred to as Patent Document 2).

On the other hand, a core material has been developed, which is made by roiling amorphous ribbon microcrystalline material ribbon, and winding a conductive wire thereto, and is used as an inductor or transformer that has high saturation magnetization and further small magnetic loss (core loss). For example, a dust core for an inductor having high saturation magnetization and low loss has been suggested, which is obtained by powderizing an amorphous material of a Fe—Si-based alloy or a Fe—Si—Al-based alloy, mixing the amorphous powder with a non-magnetic binder such as a resin, compacting the mixture into a desired shape, and heat-treating it, as described in Otsuka, Endo, Koshimoto, Yamamoto, Okuno, Yoshino, Fukami and Yagi; “Fabrication of Fe-Based Amorphous Powders by the Spinning Water Atomization Process, and the Magnetic Properties of Their Compressed Powder Cores”, Journal of Magnetics Society of Japan 21(4-2), 617-620, 1997 (hereinafter, referred to as Non-Patent Document 1).

In addition, Jpn. Pat. Appln. KOKAI Publication No. 2000-30925 (hereinafter, referred to as Patent Document 3) describes a method of manufacturing a dust core to improve the mechanical strength by mixing and compacting atomized powder of a soft magnetic alloy and a silicone resin (compacting additive), and heat-treating and then impregnating the compact with an epoxy resin or a silicone resin, and heat-curing the impregnation resin.

### BRIEF SUMMARY OF THE INVENTION

A conventional dust core is manufactured by mixing soft magnetic metal powder, and a water glass or a silicone resin, and subjecting the mixture to die pressure compacting and heat treatment step.

However, if the manufacturing method that has been applied to these crystalline soft magnetic metal powder, is applied to an amorphous soft magnetic metal powder, there is a problem such that the strength becomes deteriorated and providing to actual use is impossible. Furthermore, if the strength is improved within the range of the conventional manufacturing method described in the Non-Patent Document 1, reversely, the core loss property causes deterioration of the magnetic permeability and decrease of the performance in comparison with the case where crystalline soft magnetic metal powder is used. As en improvement strategy therefor, coating of a coating material onto the surface of a dust core using a surface coating method has been also considered. However, with this method, distortion due to contraction of the coating film generated in the course of solidification of the coating material after the coating, deteriorates the performance of the magnetic body. Therefore, the surface coating method is neither effective means for solving the problems. As described above, the conventional methods have a problem of not effectively using basic properties of amorphous powder.

On the premise of the above-mentioned problems, in the case of conventional crystalline soft magnetic metal powder, it has been obtain a spherical powder (since the alloy is soft and a mechanical pulverization is not possible) if the powder shape is close to spherical form to improve direct current superposition property or powder is manufactured with a water atomization method or a gas atomization method to obtain alloy powders having a small content of Si and Al of the Fe—Si—Al alloy spherical particles. And a dust core using-such powder has insufficient strength, and thus is difficult to provide for actual use.

Furthermore, a ferrite is preferentially applied and studied in the inductor market although a dust core corresponds better to technical needs than ferrite, and the dust core is adopted only if there is no other choice. The reason is that the dust core has bad compactibility, and easily has breakage or crack at the time of a compacting step, and thus has low manufacture yield ratio, and in fact has higher manufacturing cost than the ferrite. For example, with the conventional method of Patent Document 3, if amorphous alloy powder is used as atomized powder in the compacting step, it causes various problems such that a mixture of the amorphous alloy powder and the silicone resin has poor flowability, which leads to no increase of the compacting speed; the powder is sandwiched between the die and the punch, which leads to breakage of the die and the punch and accordingly to lowering of capacity utilization; failure of the compact occurs leading to low yield ratio; and further arbitrary property of the compact shape exhibited in the ferrite is not secured. Due to such poor compactibility, the dust core is min to ferrite at any time, which is a main cause to the minor position in the competition.

The present invention has been invented to solve the above-mentioned problems, and the object of the present invention is to provide a composite magnetic material that is excellent in magnetic properties such as magnetic permeability and core loss, and has practical strength, and a method for manufacturing a composite magnetic material that can improve compactibility of a dust core and reduce manufacturing cost.

### MEANS TO SOLVE A PROBLEM

To solve the above-mentioned problems, the inventors have studied earnestly in regard to the reaction behavior of soft magnetic metal powder and a binder in each manufacturing process of a dust core, and a change resulting therefrom of mechanical strength and magnetic properties. As a result, the present inventors have obtained the findings described below.

In a conventional manufacturing method, amorphous powder of a soft magnetic metal and ceramics such as silicone resin or water glass are mixed, dried and then subjected to die-compacting, to obtain a compact of the product shape, and then the strain at the time of the compacting resulting from the amorphous powder is further eliminated, whereby to express various properties of a magnetic body (magnetic permeability, core loss, mechanical strength and the like).

With a conventional manufacturing method using crystalline powder heat treatment at high temperature where the strain can be sufficiently eliminated, is performed whereby to secure desired magnetic properties, and the silicone resin is degraded to become a ceramic phase such as silicon oxide, or the water glass releases the crystal water to become a ceramic phase mainly having silicate soda, whereby to obtain practical strength.

On the other hand, with a manufacturing method using amorphous powder, if the temperature of the heat treatment is elevated to a higher temperature than the crystallization temperature of the amorphous phase in order to obtain high enough temperature to eliminate the strain, the amorphous phase is crystallized so that the loss property (core loss) is rapidly deteriorated. If the temperature of the heat treatment is lowered to the crystallization temperature of the amorphous phase or less in order to prevent deterioration of this loss property (core loss), degradation of the silicone resin and stabilization of the water class become insufficient due to the low temperature heat treatment, leading to deterioration of the mechanical strength. In addition, it has been found that the amorphous powder is harder than the crystalline powder, and thus physical bonds of the powder to each other are not generated in the compacting step, which is one factor for the deterioration of the mechanical strength.

If an addition amount of a binder is increased strength improvement, it causes deterioration of magnetic properties (magnetic permeability and the like). Furthermore, applications of various organic resins or inorganic resins instead of the silicone resin or the water glass were tried as a binder, but any of them was transformed by the heat treatment, never leading to securing sufficient mechanical strength.

Furthermore, as a result of analysis manufacturing processes for a dust core, it was found that the manufacturing method of the Patent Document 3 has a problem particularly in the compacting step. It was found that factors of causing high cost in the compacting step of the manufacturing process for a dust core are such that mixed powders comprising soft magnetic powder and a binder have poor flowability and compactibility, which leads to no increase of the compacting speed; the powders are sandwiched between the die and the punch, which leads to breakage of the die and the punch, and accordingly to lowering of capacity utilization; failure of the compact occurs leading to low yield ratio; and further arbitrary property of the compact shape exhibited in the ferrite is not secured.

Further profound studies for this factor have revealed that the problem of the powder properties of the mixed powders is due to a binder used in a dust core. That is to say, a heat treatment step for a dust is aimed to recover magnetic properties by elimination of strain, and thus if the temperature reaches a certain high temperature, an organic resin is degraded at the time of the heat treatment in such a case to lose the bonding function for magnetic powder. Consequently, a water glass and ceramic or a silicone resin is used generally, and they form a ceramic having insulation properties by the heat treatment, to give a certain bonding strength for magnetic powder. However, it was nearly impossible for these binders to satisfy powder flowability, compactibility, internal friction angle and the like, which are desired as powder for compacting.

The present inventors repeated trials and errors through various experiments regarding a manufacturing process for dust core. In a conventional process, they have obtained findings that a binder is expected to have functions and roles such as giving powder flowability at the time of the compacting by granulating magnetic powders into secondary particles; educing friction of magnetic powder in the compacting step; maintaining the strength of the compact; being degraded after heat treatment to bond magnetic powder and give a certain strength of a product; and insulating between magnetic powder.

On the basis of these findings, it has been found by the present invention that the process described below is optimal as a method for manufacturing a composite magnetic material (dust core) using soft magnetic alloy powders. Specifically, the method for manufacturing a composite magnetic material of the present invention comprises mixing soft magnetic alloy powders and a compacting additive (resin), drying, granulating, die-compacting and heat-treating the mixture, and impregnating the mixture with a resin in order to reinforce mechanical strength deteriorated by degradation of the compacting additive by the heat treatment, and heat-curing the impregnation resin if necessary.

Furthermore, when amorphous powders are used as the soft magnetic alloy powder, heat treatment at a lower temperature than the crystallization temperature makes it possible to obtain effects of preventing crystallization of the amorphous phase, and further also securing mechanical strength of the compact.

A composite magnetic material for an inductor, in which a soft magnetic metal powder is bonded with a non-magnetic material, wherein the non-magnetic material contains a first binder as a compacting additive that contains an organic resin, and is added to and mixed with the soft magnetic metal powder, and second binder that is impregnated to a compact as a binder after the heat treatment of the compact obtained by adding the first binder to the soft magnetic metal powder and compacting it, and is heat-cured; wherein the organic resin comprises one or two or more selected from the group consisting of polyvinyl butyral (PVB), polyvinyl alcohol (PVA), methyl cellulose (MC), water-soluble acrylic binder (AC), paraffin, glycerin and polyethylene glycol, and has granulability, compactibility, shape retentability and thermal degradability; and the soft magnetic metal powder contains 40% by mass or more (including 100%) of spherical particles of which the ratio L₂/L₁ between a perimeter L₁ of a particle cross-section in the two dimensional plane view and a perimeter L₂ of a circle having equivalent cross-sectional area is 0.5 or more.

A method of producing a composite magnetic material for an inductor, in which a soft magnetic metal powder is bonded with a non-magnetic material, comprising: (a) preparing the soft magnetic metal powder contains 40% by mass or more (including 100%) of spherical particles of which the ratio L₂/L₁ between a perimeter L₁ of a particle cross-section in the two dimensional plane view and a perimeter L₂ of a circle having equivalent cross-sectional area is 0.5 or more, and mixing the soft magnetic metal powders with a first binder comprising one or two or more organic resins selected from the group consisting of polyvinyl butyral (PVB), polyvinyl alcohol (PVA), methyl cellulose (MC) water-soluble acrylic binder (AC), paraffin, glycerin and polyethylene glycol in a predetermined ratio, wherein the organic resin has granulability, formability, shape retentability and thermal degradability, (b) compacting the mixture obtained in the (a) step into a desired shape, (c) heat-treating the compact obtained in the (b) step under predetermined conditions, and heat-degrading the organic resin to form voids between the particles of the soft magnetic metal powders, (d) impregnating the compact after the heat treatment with a second binder comprising one or two or more selected from the group consisting of a silicone resin, an organic resin and a water glass under predetermined conditions, whereby filling the voids formed in the (c) step with the second binder, and then heating the compact to cure the second binder.

As described above, in the present invention, functions of a binder are considered as divided into a function of being involved in compactibility expected for a raw material before heat treatment, and a function of being involved in product properties after heat treatment, and the present invention uses a combination of a first binder (compacting additive) and a second binder (impregnation resin), which are suitable for each of the functions as a binder.

The first binder is characterized by comprising 20% by mass or more (including 100%) of an organic resin and 80% by mass or less (including 0%) of a silicone resin, or 30% by mass or more (including 100%) of an organic resin and 70% or less (including of ceramic. The organic resin in the first binder comprises one or two or more selected from the group consisting of polyvinyl butyral (PVB), polyvinyl alcohol (PVA), methyl cellulose (MC), water-soluble acrylic binder (AC), paraffin, glycerin and polyethylene glycol, and is heat-degraded in the (c) step.

Furthermore, in the present invention, the resin impregnation step is added after the heat treatment in addition to the steps before the heat treatment, i.e., the (a) mixing step and the (b) compacting step, with the (c) heat treatment step as a border. In other words, by adding the (d) resin impregnation step after the (c) heat treatment stem, it is possible to secure both of bond strength and insulation of magnetic powders by the second binder impregnation resin) even if the first binder (compacting additive) contained in the compact is damaged with the heat treatment step.

As a result, it is possible to select a material aimed to improve formability as the first binder (compacting additive), and reduce the amount of a resin that has been conventionally increased for some improvement using a binder having poor formability, and also improve properties of a product.

### BRIEF DESCRIPTION OF THE SEVERAL VIEWS OF THE DRAWING

FIG. 1 is a flow sheet showing a method for manufacturing a composite magnetic material that relates to an embodiment of the present invention;

FIG. 2A is a cross-sectional pattern diagram showing a change of the micro constitution of a composite magnetic material that is manufactured using the method of the present invention;

FIG. 2B is a cross-sectional pattern diagram showing a change of the micro constitution of a composite magnetic material that is manufactured using a conventional method;

FIG. 3A is an elevational view showing an example a toroidal form inductor;

FIG. 3B is a lateral view showing an example toroidal form inductor;

FIG. 4A is an elevational view showing an example of another type of the toroidal form inductor;

FIG. 4B is a lateral view showing an example of another type of the toroidal form inductor;

FIG. 5A is an exploded lateral view showing components of a variant inductor before assembling;

FIG. 5B is a complete lateral view showing a variant inductor after assembling;

FIG. 6A is a plane view of a variant inductor;

FIG. 6B is a lateral view of a variant inductor;

FIG. 6C is an elevational view of a variant inductor;

FIG. 7(a) is an elevational view of a core compact, and FIG. 7(b) is a lateral view of a core compact;

FIG. 8(a) is a view as seen laterally of a tension testing machine when a sample for measurement is installed, and FIG. 8(b) is a view as seen frontally of the same tension testing machine;

FIG. 9 is a diagrammatic property view showing effects of the present invention;

FIG. 10A is a microscopic photograph of constitution showing a composite magnetic material (dust core) having pure iron powders as raw materials;

FIG. 10B is a microscopic photograph of constitution showing a composite magnetic material (dust core) having non-crystalline soft magnetic metal powders as raw materials;

FIG. 11 is a diagrammatic property view showing results of an infrared spectroscopy analysis strength evaluation; and

FIG. 12 is a flow sheet showing a conventional manufacturing method.

### DETAILED DESCRIPTION OF THE INVENTION

The composite magnetic material of the present invention is a composite magnetic material for an inductor in which soft magnetic metal powder is bonded with a non-magnetic material, wherein the non-magnetic material (the first binder) contains an organic resin, and is added to and mixed with the soft magnetic metal powders as a compacting additive. The organic resin comprises one or two or more selected from the group consisting of polyvinyl butyral (PVB), polyvinyl alcohol (PVA), methyl cellulose (MC), water-soluble acrylic binder (AC), paraffin, glycerin and polyethylene glycol, and has granulability, formability, shape retentability and thermal degradability. The second binder is impregnated to the compact of the soft magnetic metal powder and the non-magnetic material as a binder after heat treatment, and heat-cured. The soft magnetic metal powder contains 40% by mass or more (including 100%) of spherical particles of which the ratio L₂/L₁ between a perimeter L₁ of a particle cross-section in the two dimensional plane view and a perimeter L₂ of a circle having equivalent cross-sectional area is 0.5 or more.

The manufacturing method for a composite magnetic material of the present invention is a manufacturing method for a composite magnetic material for an inductor, in which soft magnetic metal powder is bonded with a non-magnetic material, comprising (a) preparing magnetic metal powder containing 40% by mass or more (including 100%) of spherical particles of which the ratio L₂/L₁ between a perimeter L₁ of a particle cross-section in the two dimensional plane view and a perimeter L2 of a circle having equivalent cross-sectional area is 0.5 or more, mixing the soft magnetic metal powders with a first binder comprising a non-magnetic material as a compacting additive in a predetermined ratio, (b) compacting the mixture into a desired shape, (c) heat-treating the compact under predetermined conditions, (d) impregnating the compact after the heat treatment with a second binder comprising one or two or more selected from the group consisting of a silicone resin, an organic resin and a water glass under predetermined conditions.

By adding the resin impregnation step after the heat treatment step in the present invention, which is absent in a conventional manufacturing method, the strength that is deteriorated by the heat treatment can be elevated, and magnetic properties can be expressed with practical strength. Furthermore, the conventional method has problems such that a desired strength level cannot be secured by increase of the resin amount and accordingly magnetic properties are deteriorated. However, such problems are resolved by the present invention. The present invention is effective for various soft magnetic powder, and particularly more effective for particles as much as the shape thereof is closer to a spherical form. Namely, use of spherical closely spherical soft magnetic powders by the sent invention allow a balance of mechanical strength with loss property.

The soft magnetic metal powders in the present invention are preferably particles obtained using a water atomization method or a gas atomization method. The water atomization powders obtained by blowing molten metal into a water flow, or the gas atomization powders obtained by blowing a molten metal into a gas flow comprise particles of an approximately spherical shape, i.e., closely spherical form. These particles of an approximately spherical shape have excellent magnetic properties, which allow a balance of mechanical strength with magnetic properties (loss property and the like) in a high dimensional level. The present invention realizes obtaining a compact that contains particles of an approximately spherical shape by the resin impregnation treatment of the compact after heat treatment, and has practical strength.

The soft magnetic metal powders manufactured using the water atomization method or the gas atomization method in the present invention are preferably amorphous particles. In addition, the soft magnetic metal powders are preferably amorphous particles obtained by mechanical pulverization of a ribbon or lump amorphous material. By performing a series of steps comprising mixing of magnetic powders and a compacting additive → compacting → heat treatment → and binder impregnation using atomized amorphous particles or mechanically pulverized amorphous particles, which was difficult to compact with the conventional method, it is possible to balance mechanical strength with loss property of the composite magnetic material in a good balance.

In addition, the soft magnetic metal powder in the present invention may be microcrystalline particles obtained using the water atomization method or the gas atomization method, or may be microcrystalline particles obtained by mechanical pulverization of a ribbon or lump amorphous material. Not only the amorphous particles, but also the microcrystalline particles are effectively used in the present invention. Furthermore, suppression of oxidation of the amorphous particles and the microcrystalline particles at the heat treatment step by the above-mentioned series of the steps in the present invention is effective in prevention of deterioration of loss property.

The soft magnetic metal powders in the present invention may be crystalline particles obtained by mechanical pulverization of a lump alloy. It is possible to suppress strength deterioration and secure practical strength, which occurs when the powder shape is made to a closely spherical form. In this case, the crystalline particles contain 3% by mass or more and 10% by mass or less of Si, and the balance consists of Fe and inevitable impurities, and further preferably, the crystalline particles contain 6% by mass or less (including 0%) of Al, and the balance consists and Si and inevitable impurities. The alloy of such composition allows a balance of mechanical strength with loss property of the composite magnetic material in high dimension.

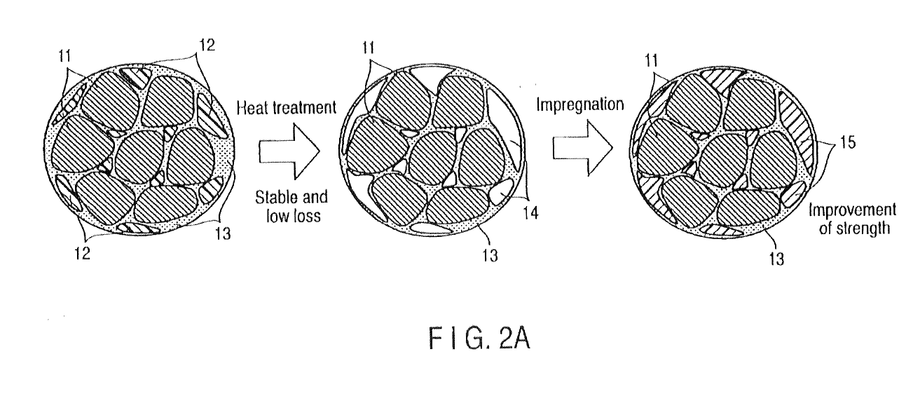

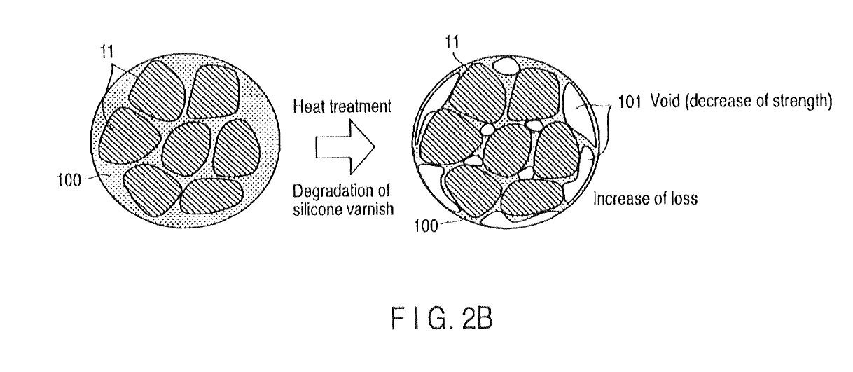

The first binder as a compacting additive in the present invention contains 20% by mass or more (including 100%) of an organic resin and 80% by mass or less (including 0%) of a silicone resin, which makes it possible to improve granulatability of the soft magnetic metal powders and thus secure compactibility, and reduce compacting cost. Namely, the organic resin has a function as a compacting additive of securing granulatability, compactibility and compact shape retainability, respectively, and then is nearly complete degraded and disappears with following heat treatment, while the silicone resin has a function as a strength material that is degraded at the time of the heat treatment to become ceramics and remains in the final product. Furthermore, by impregnating the compact with the second binder after the heat treatment, possible to recover the strength of the compact, which is deteriorated by the heat treatment (see FIG. 2A). As the second binder, silicone resin, an organic resin and a water glass may be used.

The reason for the prescription that the content rate of the organic resin is 20% or more and 100% or less (including 100%), and the content rate of the silicone resin is 80% or less (including 0%) in the first binder, is a balance of various properties at the time of the compacting and strength retention necessary for handling products after the heat treatment and before the impregnation. Namely, the reason is that if the content rate of the organic resin is less than 20% by mass, and the content rate of the silicone resin is more than 80% by mass, damage occurs in granulatability, compactibility and compact shape retainability, and thus the good product rate decreases.

In the (a) step in the present invention, it is preferable that the first binder which is soluble to an organic solvent and the soft magnetic metal powder, are weighed respectively, and the two are wet-mixed, and then dried and granulated. A mixture of the organic resin and the silicone resin is dissolved in an organic solvent, added with the magnetic powder, and the mixture is mixed with agitation, dried and granulated, to obtain granulated bodies of mixed powders, whereby each component is uniformly mixed together, and powder properties (granulatability, compactibility, compact shape retainability) at the time of the compacting are excellent.

In step (a), it is preferable that a silicone resin and soft magnetic metal powder are weighed respectively, and the two are wet-mixed, dried, and then a water-soluble organic resin as the organic resin is weighed, the weighed water-soluble organic resin is wet-mixed with the mixed powders of the soft magnetic metal powder and the silicone resin, and then dried and granulated. A process has been prescribed when the water-soluble organic resin is applied. Namely, the silicone resin and the soft magnetic metal powder are weighed respectively and blended, and these are dissolved in an organic solvent, agitated and mixed, and then dried. This dry substance and the water-soluble organic resin are weighed and blended, and dissolved in water, agitated and mixed, and then dried and granulated. In this case, the magnetic powder is conceptually coated by two layers comprising the silicone layer and the organic resin onto the surface thereof, and granulated with the first binder (compacting additive) to form secondary particles, whereby the function of the first binder becomes remarkable at the time of the compacting.

In step (a), it is preferable that a silicone resin and the soft magnetic metal powder are weighed respectively, wet-mixed, dried, and then a thermoplastic resin as the organic resin is weighed, and the weighed thermoplastic resin and mixed powders or the soft magnetic metal powder and the silicone resin are heat-mixed and granulated. When thermoplastic resin is used as the organic resin, heat dissolution step may be applied instead of the step using an organic solvent, which is excellent in view of environmental sanitation.

The second binder in the present invention comprises one or two or more selected from the group consisting of a silicone resin, an organic resin and a water glass, and the compact is preferably further heat-treated after step (d). As a resin impregnated to the compact as the second binder, a silicone resin, an organic resin, a water glass and the like may be used, and can exert maximum effects by a suitable combination to the magnetic material. However, heat-curing treatment (curing) is further desirably added to cure the compact from the viewpoint of long term stability of the performances.

Furthermore, the second binder in the present invention preferably has a molecular structure in a single body form. As a result of investigation for the relationship of a binding layer form in a product and a product performance, the second binder desirably has an originally possessed molecular structure. That is say, careless heat treatment at high temperature may cause strength deterioration and magnetic property deterioration after the curing, and thus the second binder form has been prescribed as described above.

In step (d), the impregnation may be performed by immersing the compact in a solvent containing the second binder for 1 hour or so under atmospheric pressure. In this case, 20% or so of the voids of the compact are filled with the second binder, and the following heat treatment leads the strength of the compact to reach the practical strength or more. Herein, the “practical strength” refers to 40 MN/m2 or more for a compact comprising powder by mechanical pulverization of crystalline particles, and 20 MN/m2 or more for a compact comprising closely spherical powder such as amorphous powder and atomized powder. However, necessity of long time for the impregnation step is not preferable in view of productivity. Consequently, if the voids of the compact are gas-removed under vacuum reduced pressure, and the second binder is impregnated thereto, the step is completed within 10 minutes under 0.01 MPa or less of the treatment atmosphere. As a matter of course, pressurization, or combination of vacuum and pressurization may be also performed after immersion of the compact in the solvent containing the second binder. However, the pressurization needs big equipment, which raises the cost. Therefore, the vacuum impregnation method is more practical. Furthermore, if the treatment time is significantly extended, impregnation under atmospheric pressure with the second binder may be also performed to the compact. However, the productivity considerably decreases, whereby the method is not proper in industrial production. Generally, the “impregnation under atmospheric pressure” is not a practical method, but is still a method allowing manufacture of the present invention product.

On the other hand, the present invention may use a first binder comprising 30 by mass or more (including 100%) of an organic resin and 70% or less (including 0%) of ceramics as a compacting additive. In comparison with the above-mentioned invention wherein the silicone resin is used as the first binder (compacting additive), the present invention is somewhat inferior in the point of compactibility, but advantageous in view of cost, and allows use of a product under high temperature.

The present invention, which relates to the mixing step of the first binder (compacting additive), comprises steps of dissolving ceramics and an organic resin in an organic solvent, mixing with agitation, drying and granulating it. By such steps, stable powder properties are obtained.

The reason for the prescription that the content rate of the organic resin is 30% or more and 100% or less (including 100%), and the content rate of the ceramics is 70% or less (including 0%) in the first binder, is a balance of various properties at the time of the compacting and strength retention necessary for handling products after the heat treatment and before the impregnation. Namely, the reason is that if the content rate of the organic resin is less than 30% by mass, and the content rate of the ceramics is more than 70% by mass, damage occurs in granulatability, compactibility and compact shape retainability, and thus the good product rate decreases. As the first binder in the present invention, 100% organic resin containing no ceramics may be also used.

In the (a) step in the present invention, it is preferable that the first binder which is soluble to an organic solvent and the soft magnetic metal powders, are weighed respectively, and the two are wet-mixed, and then dried and granulated. The organic resin is generally often used as dissolved in an organic solvent, and thus the organic resin is prescribed as those soluble in an organic solvent in the present embodiment. By using an organic solvent as a solvent, the soft magnetic metal powder can be uniformly dispersed over the whole compact.

In step (a), it is preferable that the first binder which is soluble to water and the soft magnetic metal powders, are weighed respectively, and the two wet-mixed, and then dried and granulated. The ceramics are generally often used as dissolved in water, and thus the ceramics are prescribed as those soluble in water in the present embodiment. By using water as a solvent, it is excellent in both views of cost and environment.

Furthermore, in the present invention, it is preferable that the ceramic and the soft magnetic metal powder are weighed respectively, wet-mixed using water as a dispersion media, dried, and then a thermoplastic resin as the organic resin is weighed, and the weighed thermoplastic resin is heat-mixed with mixed powders of the soft magnetic metal powder and the ceramics, and granulated. When a thermoplastic resin is used as the organic resin, heat dissolution step may be applied instead of the step using an organic solvent, which is excellent in view of environmental sanitation.

The second binder in the present invention comprises one or two or more selected from the group consisting of a silicone resin, an organic resin and a water glass, and the compact is preferably further heat-treated after impregnation step (d). Maximum effects can be exerted by a suitable combination to the magnetic material. However, heat-curing treatment (curing) is further desirably added to cure the compact from the viewpoint of long term stability of the performances.

Hereinafter, various embodiments of the present invention will be explained with reference accompanied drawings.

### (Manufacture of Composite Magnetic Material)

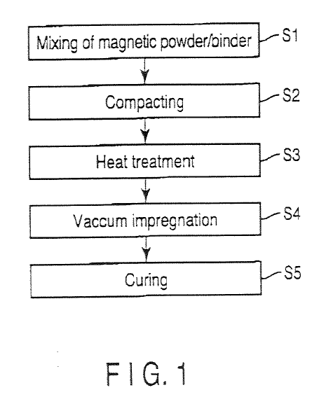

Manufacture of a dust core compact as a composite magnetic material using the method of the present invention will be explained with reference to FIG. 1 and FIG. 2A.

First, soft magnetic metal powders 11 and a first binder (compacting additive) are mixed in a predetermined blending ratio (step S1). The first binder comprises those previously mixed of an organic resin 12 and a silicone resin (or ceramic) 13 in a desired ratio. The organic resin 12 comprises polyvinyl butyral (PVB), polyvinyl alcohol (PVA), methyl cellulose (MC), water-soluble acrylic binder (AC), paraffin, glycerin, polyethylene glycol and the like. The ceramics 13 comprises so-called clay minerals (for example, kaolin, kibushi clay and bentonite) such as kaolinite, montmorillonite and the like, a water glass and a frit.

The mixture of the magnetic powder/compacting additive is kneaded and granulated, and compacted into a desired shape using a compacting process machine (Tamagawa TTC-20) (step S2). In the present invention, the first binder (compacting additive) contains the organic resin 12, which allows good compactibility. Particularly, even with faster compacting velocity than that of the conventional method, breakage or crack to the compact is not generated, shape retainability after compacting is also very good.

Then, the compact is charged into heat equipment, and heat-treated at predetermined conditions (step S3). When the soft magnetic metal powders are a crystalline alloy in this heat treatment step S3, it is preferable that the heating temperature is 600 to 800° C., and the heating time is 60 to 180 minutes. In other words, if the heating temperature is less than 600° C. when the soft magnetic metal powders are a crystalline alloy, elimination of strain is insufficient and thus desired magnetic properties are not obtained. On the other hand, if the heating temperature is more than 800° C., there is deterioration of loss property due to change of the constitution of the first binder. From this, the above-mentioned temperature range is desirable. In addition, when the soft magnetic metal powders are amorphous alloy, it is preferable that the heating temperature is 300° C. or more and equal to or less than the crystallization temperature of the amorphous alloy, and the heating time is 60 to 180 minutes. If the heating temperature is more than the crystallization temperature of the amorphous alloy when the soft magnetic metal powder is an amorphous alloy, the amorphous phase is crystallized and thus loss property (core loss) is deteriorated. On the other hand, if the heating temperature is less than 300° C., elimination strain becomes insufficient, and desired magnetic properties are not obtained. In addition, the reason for the prescription that the heating time is 60 to 180 minutes, is that if the heating time is shorter than 60 minutes, elimination of strain becomes insufficient, and on the other hand, if the heating time is more than 180 minutes, problems occur in productivity.

Since the first binder (the compacting additive) in the present invention contains the organic resin 12 and the silicone resin or ceramics 13, they are bonded to each other to give some degree of strength. However, most or all of the organic resin in the first binder is heat-degraded and disappears by the heat treatment, and many voids 14 occur in a base 13 as shown in FIG. 2A, and therefore, it cannot be said necessarily that the compact has sufficient strength at this stage.

Then, the compact after the heat treatment is charged into a vacuum treatment room and immersed in an impregnation resin solution as the second binder. The vacuum treatment room is vacuum-aspirated to have reduced pressure atmosphere equal to or less than predetermined pressure, and the second binder 15 is vacuum-impregnated to the core compact (step S4), whereby the voids 14 existing in the base 13 are filled with the second binder 15. After the impregnation treatment, the compact is heated at predetermined conditions to cure the impregnation resin of the second binder 15 sufficiently (step S5). As a result, mechanical strength of the compact improves. By the steps as described above, a dust core compact for an inductor having good compactibility is obtained.

The organic resin in the first binder in the present invention has functions as a compacting additive that secures granulatability, compactibility and compact shape retainability, respectively, and is nearly completely degraded and disappears with the following heat treatment. On the other hand, the silicone resin in the first binder has functions as a strength material that is degraded at the time of the heat treatment be ceramics, and remains in a final product. Furthermore, the second binder has functions as a reinforcing material that is cured by the heat-curing treatment to significantly improve the compact strength.

Herein, a conventional manufacturing method that is compared with the manufacturing method of the present invention will be explained with reference to FIG. 12 and FIG. 2B.

First, soft magnetic metal powder 11 and a silicone resin 100 are mixed (step K1). The silicone resin of the conventional method is recognized to have many functions such as granulatability, compactibility as a compacting additive, a strength component as a binder and insulation properties. However, the silicone resin has weak binding force to particles of the magnetic powder, and flowability of the magnetic powder is poor. Thus, the compacting step is difficult per se with the silicone resin, and the silicone resin is inferior in compactibility such as large variation of the compact shape. Furthermore, in order compensate these disadvantages, the silicone resin is often excessively added to and mixed with the magnetic powder in the conventional method described in Patent Document 3.

The mixture of the magnetic powder/the silicone resin are kneaded and dried to prepare mixed powders, which is compacted into a desired shape with a die press and the like (step K2).

Then, the compact is heat-treated at predetermined conditions step K3). The object of this heat treatment is to eliminate strain of the compact. When the soft magnetic metal powder is a crystalline alloy, the heating temperature is 600 to 900° C., and the heating time is 60 to 180 minutes. If the heating temperature is lower, elimination of strain is insufficient and thus desired magnetic properties are not obtained. On the other hand, if the heating temperature is too high, there is deterioration of loss property due to change the constitution of the silicone resin. Therefore, the above-mentioned temperature range is desirable. In addition, when the soft magnetic metal powder is an amorphous alloy, the heating temperature is 300° C. or more and equal to or less than the crystallization temperature, and the heating time is 60 to 180 minutes. If the heating temperature is lower than 300° C., elimination of strain becomes insufficient and thus desired magnetic properties are not obtained. On the other hand, if the heating temperature is more than the crystallization temperature, the amorphous phase is crystallized and thus loss property (core loss) is deteriorated. Therefore, the above-mentioned temperature range is desirable. Similarly, if the heating time is shorter, elimination of strain becomes insufficient, and if the heating time is too long, problems occur in productivity. Many voids 101 occur in a compact base 100 by this heat treatment as shown in FIG. 2B, and the strength decreases.

### (Manufacture of Inductor)

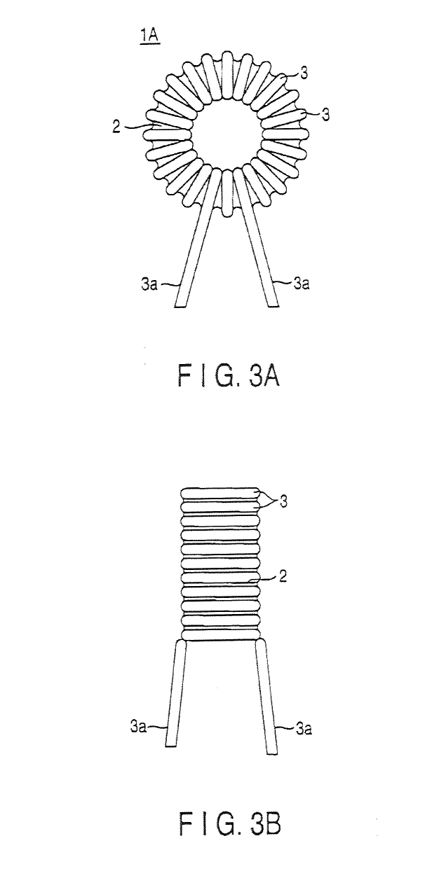

Next, manufacture of various inductors (coil) will be explained with reference to FIG. 3A to FIG. 6C.

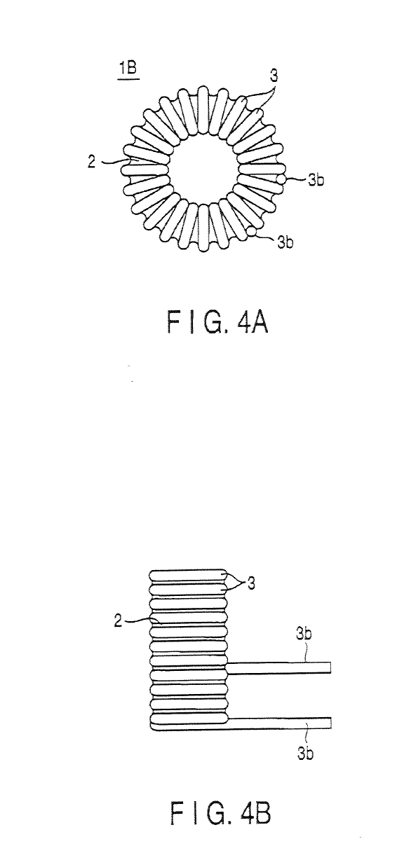

FIG. 3A, FIG. 3B, FIG. 4A and FIG. 4B show inductors 1A and 1B, respectively that are obtained by impregnating a compact 2 of a composite magnetic material (dust core), which is compacted to a toroidal shape and heat-treated, with a second binder, and rolling a winding wire conductor 3 thereon. FIG. 3A and FIG. 3B show a vertical type coil (inductor) that is obtained by projecting both ends of the winding wire conductor as a lead terminal 3a to the lateral direction of the compact 2 in a toroidal shape, and placing the lateral side of the compact 2 on a print substrate to be mounted. FIG. 4A and FIG. 4B show a horizontal type coil (inductor) that is obtained by projecting both ends of the winding wire conductor 3 as a lead terminal 3b to the lateral direction of the compact 2 of a toroidal shape, and placing the bottom of the compact 2 on a print substrate to be mounted.

The above-mentioned toroidal form inductors 1A and 1B are obtained by coating the whole compact 2 with an insulating resin by an immersion method, and then heating and drying it, and rolling up a winding wire conductor 3 thereon. Such toroidal form inductors 1A and 1B are mainly used as a chalk coil as a filter for prevention of noise generated at the time of switching of a thyristor application product, or for prevention noise of a switching power.

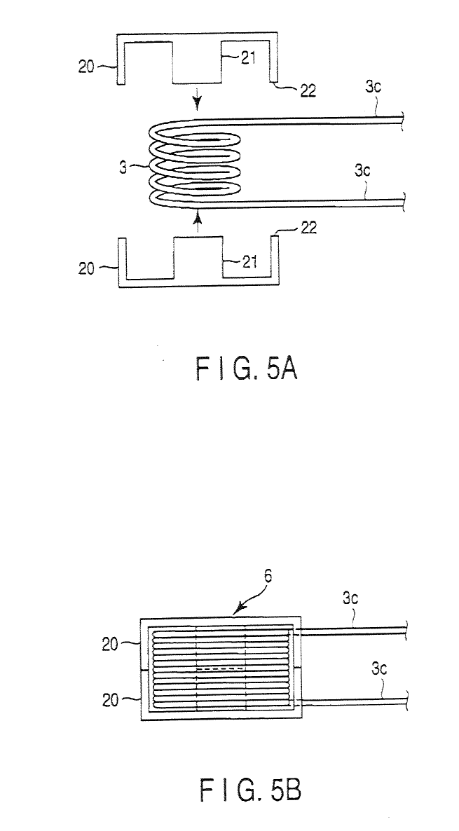

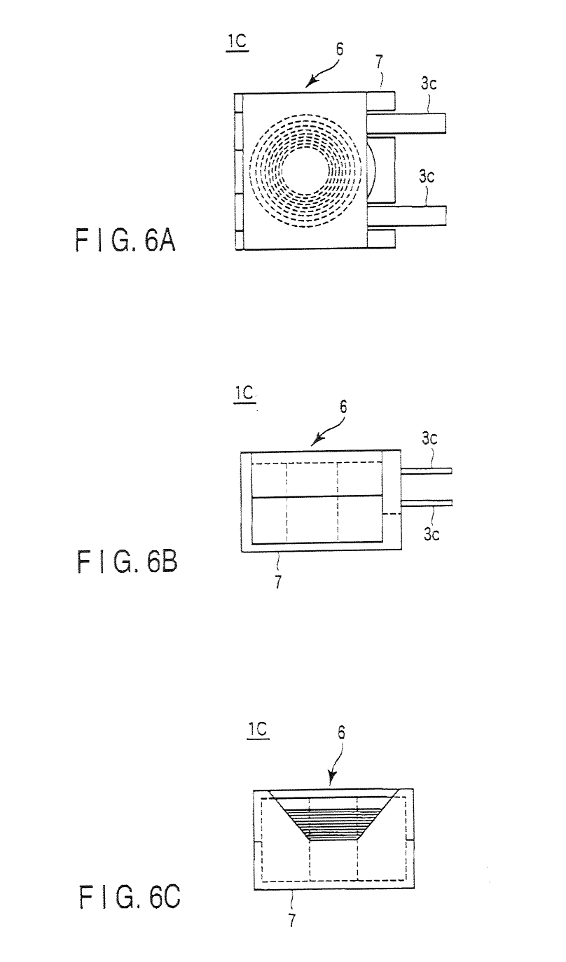

Next, variant inductors (coil) will be explained with reference to FIG. 5A, FIG. 5B, FIG. 6A, FIG. 6B and FIG. 6C.

First, a manufacture method for a variant inductor will be explained. The core compact 20 shown in FIG. 5A is integrally compacted by a pressure compacting method, and has an outer circumferential portion 22 having “C” shape in the cross-section, and a cylindrical central portion 21. The cylindrical central portion 21 is arranged as spaced from the both lateral walls of the outer circumferential portion 22, and a certain space is formed for receiving a coil 3 between the lateral wall of the outer circumferential portion 22 and the cylindrical central portion 21. Such core compact 20 is prepared in two, and these are placed opposite to so as to face each other, and the central portions 21 of a pair of the core compacts 20 are inserted into the coil 3 previously coiling-processed. The end faces of the outer circumferential portion 22 of the core compact 20 are adheaded each other with an adhesive and the end faces of the central portion 21 of the core compact 20 are adheaded each other, respectively to form a coil assembly 6 shown in FIG. 52. In such coil assembly 6, the cylindrical central portion 21 are nearly covered by the coil 3 and hidden, and the both ends of the coil 3 project from the outer circumferential portion 22 to the outside as lead terminals 3c of the positive and negative electrodes. Then, a pair of insulating cases 7 are adhered to both lateral sides of the coil assembly 6 as shown in FIG. 6A, FIG. 65 and FIG. 6C, and the apertures in both sides of the coil assemblies 6 are blocked. This gives a variant inductor (coil) 1C shown in the drawing.

### EXAMPLES

Hereinafter, various embodiments and Examples of the present invention will be explained by illustrative embodiments.

### First Embodiment

As the first embodiment of the present invention, a Fe alloy having a rough composition of 9.6% Si and 5.5% Al obtained by a vacuum dissolution method was manufactured, and sieve-isolated with control of powder treatment step conditions by mechanical pulverization, to manufacture alloy powder having different sphericities. 0.04 of the first binder (the compacting additive) by the mass ratio was added to the alloy powder, and the mixture was wet-mixed using methylethyl ketone and granulated while being heat-dried, to obtain mixed powders. The silicone resin and the organic resin were blended as the first binder in a ratio of silicone resin:organic resin=1:1.

0.012 of zinc stearate by the mass ratio was further added and mixed to the mixed powders, and the mixture was compacted into a product shape having 21 mm of the outer diameter, 12 mm of the inner diameter and 7 mm of the height at about 1.5 GPa pressure using a mechanical compacting machine. This compact was placed in nitrogen atmosphere and heat-treated at 650° C. for 1 hour. Furthermore, an epoxy resin as the second binder was vacuum-impregnated under 0.01 MPa of reduced pressure, and the impregnation resin was heat-curing treated at 150° C. for 30 minutes, and then the strength was measured.

As a Comparative Example, 0.04 of a silicone resin by the mass ratio was added to the above-mentioned soft magnetic metal powder, and the mixture was wet-mixed using methylethyl ketone as a dispersion solvent, dried and granulated, and then added with zinc stearate and mixed, to obtain mixed powders. The tests as described above were also conducted for the samples of the Comparative Example.

### Evaluation Method Of Sphericity)

As the evaluation of sphericity, a representative sample of the powders was embedded into a resin, and the cross-section was ground, and the shape of the powder was observed by a microscope, and the perimeter L1 and the cross-sectional area S of each powder particle were measured. A circle that is equal to the measured cross-sectional area was assumed, and the circle perimeter L2 thereof was calculated, and the perimeter ratio L2/L1 was computed, which was taken as the sphericity. Namely, if L2/L1=1, it indicates a true sphere, and as the value decreases, the sphericity decreases. In addition, by mixing with powders of which L2/L1 was computed, the mixture ratio of a certain L2/L1 value powders was computed.

### (Measurement Method for Mechanical Property)

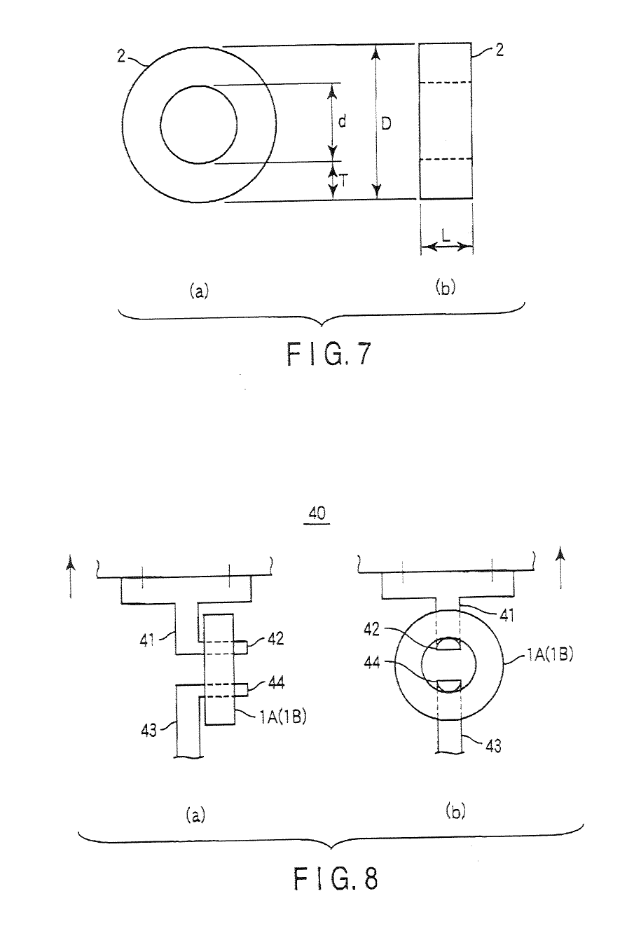

The tensile fracture strength was measured using a tension testing machine 40 (SV-55-0-50M, manufactured by Imada Seisakusho Ltd.) shown in FIG. 8. In the tension test, a fixed arm 44 and a movable arm 42 were plugged into a hollow portion of a toroidal sample 1A (1B), and stretched into a direction where the sample expands, and the load P at the time of fracture was measured, and the fracture strength was calculated by the formula (1). With respect to the strength after impregnation, the product sample of a ring shape (toroidal form sample) shown in FIG. 7 was stretched to the sample fracture using the tension testing machine 40 shown in FIG. 8, the load at the time of fracture was measured, and the fracture strength was computed by the following formula (1).

K=P(D−T)/(L*T2) (1)

Herein, K is the fracture strength (MN/m2) of the toroidal form sample, and P is the load (N) at the time of fracture. In addition, as shown at (a) in FIG. 7, D is the outer diameter (m) of the toroidal form sample, and T is a half of the difference between the outer diameter and the inner diameter of the toroidal form sample (T=(D−d)/2). In addition, as shown at (b) in FIG. 7, L is the length (m) of the toroidal form sample.

The outline the tension testing machine 40 will be explained with reference to FIG. 8. The tension testing machine 40 has a fixed arm 44 that is installed to a fixed frame 43, and a movable arm 42 that is installed to a movable frame 41. If the fixed arm 44 and the movable arm 42 are inserted into the hollow portion of the toroidal form sample 2, and the movable frame 41 is moved to a direction of departing from the fixed frame 43 by a drive mechanism not shown in the drawing, the sample 2 is loaded with tension load to be torn by the arms 42 and 44, and the load is increased fracture of the sample 1A (1B).

The mechanical strengths of the samples prepared with the powder having each L2/L1 ratio are shown in the Table 1.

TABLE 1

| | Sample | | | | | | | | |
|---|---|---|---|---|---|---|---|---|---|
| Classification | No. | Item | Measured value | | | | | | |
| Comparative | 1 | L2/L1 | 0.83 | 0.71 | 0.59 | 0.48 | 0.40 | 0.32 | 0.27 |
| Example 1 | | Strength | 2.4 | 4.3 | 8.8 | 11 | 18 | 23 | 21 |
| | | (MN/m²) | | | | | | | |
| Example 1 | 2 | L2/L1 | 0.83 | 0.71 | 0.59 | 0.48 | 0.40 | 0.32 | 0.27 |
| | | Strength | 38 | 35 | 39 | 43 | 38 | 39 | 44 |
| | | (MN/m²) | | | | | | | |

While the strength is extremely deteriorated if the ratio L2/L1 is 0.5 or more in the conventional method, the strength of the material by the present invention is maintained as nearly the same regardless of the value of the ratio L2/L1

In addition, powder having 0.5 or more of L2/L1 (powder A) and powder having 0.27 of L2/L1 (powder B) were suitably mixed to manufacture two samples 3 and 4 (Comparative Example 2 and Example 2), and the strengths of each sample were measured. The mass ratios of the powder A and the powder B, i.e., the powder A/the powder B are shown in Table 2.

TABLE 2

| | Sample | | | | | | | |
|---|---|---|---|---|---|---|---|---|
| Classification | No. | Item | Measured value | | | | | |
| Comparative | 3 | Powder A/ | 1.0 | 0.8 | 0.6 | 0.4 | 0.2 | 0.0 |
| Example 2 | | Powder B | | | | | | |
| | | Strength | 11 | 15 | 18 | 17 | 20 | 21 |
| | | (MN/m²) | | | | | | |
| Example 2 | 4 | Powder A/ | 1.0 | 0.8 | 0.6 | 0.4 | 0.2 | 0.0 |
| | | Powder B | | | | | | |
| | | Strength | 38 | 34 | 41 | 36 | 38 | 44 |
| | | (MN/m²) | | | | | | |

Example 2 showed overall strength improvement in comparison with Comparative Example 2, but the practical strength was 20 MN/m2 or so or more, and from this, it was found that the soft magnetic metal powders containing at least 40% or more of the powders that meet the condition of L2/L1>0.5 have particularly remarkable effects of the present invention.

### Second Embodiment

Crystalline powder of a Fe—Si—Al alloy was manufactured in the same manner as in the first embodiment. When the content of Si and Al was small, pulverization with usual mechanical pulverization method was difficult, and thus any powder was manufactured with the water atomization method. Using these powders, Sample 5 (Comparative Example 3) was manufactured by the conventional method, and Sample 6 (Example 3) was manufactured by the method of the present invention. The strength of each of Samples 5 and 6 was measured. Table 3 shows the Si and Al contents of the manufactured alloys by % by mass.

TABLE 3

| | Sample | | | | | | | |
|---|---|---|---|---|---|---|---|---|
| Classification | No. | Item | Measured value | | | | | |
| Comparative | 5 | Composition | 3%Si, | 6.5%Al, | 8%Si, | 10%Si, | 8%Si, | 9%Si, |
| Example 3 | | | 0%Al | 0%Al | 1%Al | 4%Al | 6%Al | 5%Al |
| | | Strength | 16.4 | 9.7 | 7.7 | 3.9 | 5.6 | 4.3 |
| | | (MN/m²) | | | | | | |
| Example 3 | 6 | Composition | 3%Si, | 6.5%Al, | 8%Si, | 10%Si, | 8%Si, | 9%Si, |
| | | | 0%Al | 0%Al | 1%Al | 4%Al | 6%Al | 5%Al |
| | | Strength | 55 | 49 | 38 | 41 | 36 | 34 |
| | | (MN/m²) | | | | | | |

From Table 3, it was shown that the strength of Sample 6 of Example 3 was higher than that of Sample 5 of Comparative Example 3 in any composition of the alloy powder.

### Third Embodiment

As the third embodiment of the present invention, Samples 7 to 13 corresponding to Examples 4 to 9 and Comparative Example 4 shown in Table 4 were manufactured respectively. Each of Samples 7 to 13 was manufactured in the manner below.

The crystalline Fe—Si—Al alloy powder having about 80 μm of the average particle size was manufactured in the same manner as in the first embodiment. 0.04 by the mass ratio of the first binder (the compacting additive) was added to these alloy powders, and the mixture was wet-mixed using methylethyl ketone, and granulated while being heat-dried, to obtain mixed powders. A silicone resin and an organic resin as the first binder were blended in a predetermined amount ratio. 50 g of granulated bodies thereof was weighed, and measured for degree of fluidity by JIS (Z2502) using infundibulum.

0.012 of zinc stearate by the mass ratio was further added to the mixed powders, and the mixture was mixed and compacted using a mechanical compacting machine, to obtain samples of Examples 4 to 9 shown in Table 4. The maximum value of the compacting velocity (piece/minute) at which good products at the time can be secured, and the good product rate (%), were investigated respectively. The results are shown as the compacting velocity and the good product rate in Table 4. The good product rate was examined visually with the naked eyes for the sample appearance. A product having no breakage or crack was determined as pass, and a product recognized to have breakage or crack was determined as no pass.

In addition, the sample of the compact was paced in nitrogen atmosphere, heat-treated for 1 hour at 800° C., and the magnetic permeability and the compact strength were measured respectively. The results are shown as the strength (MN/m2) after heat treatment and before impregnation in Table 4.

Then, an epoxy resin as the second binder was vacuum-impregnated under 0.01 MPa of reduced treasure, and the strength was measured. The results are shown as strength (MN/m2) after impregnation ad before curing in Table 4.

Furthermore, the sample after impregnation of the second binder was heat-curing treated at 50° C. for 30 minutes, and the strength was measured. The results are shown as the strength (MN/m2) after curing in Table 4.

As Comparative Example 4, 0.04 by the mass ratio the silicone resin was added to the above-mentioned soft magnetic metal powders, and the mixture was wet-mixed using methylethyl ketone as a dispersion solvent, dried and granulated, and then zinc stearate was added and mixed, to obtain mixed powders. Also for Comparative Example 4, Sample 13 of a dust core compact was manufactured, and the tests were conducted as described above. Results of these tests are shown in Table 4. Since Sample 13 of this Comparative Example 4 uses only a silicone resin as a compacting additive, Sample 13 is substantially the same as those manufactured with the conventional method described in Patent Document 3.

TABLE 4

| | Sample No. | | | | | | |
|---|---|---|---|---|---|---|---|
| | 7 | 8 | 9 | 10 | 11 | 12 | 13 |
| | Classification | | | | | | |
| | Example | Example | Example | Example | Example | Example | Comparative |
| | 4 | 5 | 6 | 7 | 8 | 9 | Example 4 |
| Content rate of organic | 10 | 20 | 40 | 60 | 80 | 100 | 0 |
| resin in first binder | | | | | | | |
| (% by mass) | | | | | | | |
| Degree of fluidity of | 100 | 39 | 40 | 26 | 20 | 20 | * |
| powder (sec) | | | | | | | |
| Compacting velocity | 8 | 11 | 14 | 15 | 17 | 17 | 6 |
| (piece/minute) | | | | | | | |
| Good product rate (%) | 100 | 100 | 100 | 100 | 100 | 100 | 91 |
| Magnetic permeability | 94 | 96 | 100 | 106 | 103 | 105 | 90 |
| Strength after heat | 24 | 20 | 19 | 18 | 16 | 9 | 26 |
| treatment and before | | | | | | | |
| impregnation (MN/m²) | | | | | | | |
| Strength after | 50 | 49 | 54 | 48 | 45 | 21 | 38 |
| impregnation and before | | | | | | | |
| curing (MN/m²) | | | | | | | |
| Strength after curing | 67 | 71 | 78 | 77 | 73 | 54 | 47 |
| (MN/m²) | | | | | | | |

Remark 1: * indicates no powder fluidity without vibration to infundibulum.

As shown in Table 4, it was possible to manufacture granulated powders having good flowability by the method of the present invention, and as a result, Examples 4 to 9 allowed significant improvement of the compacting velocity. In these Examples 4 to 9, the organic resin contained in the first binder was degraded by the heat treatment after the compacting, and thus the strength after heat treatment and before impregnation was poor. However, the voids generated by degradation of the organic resin in the first binder were filled with the second binder, and thus it was possible to obtain equal strength to that of Comparative Example. Then, it was possible to further improve the strength of the compact by heat-curing the second binder impregnation resin. Accordingly, it was and that the samples manufactured on the basis of the present invention were more excellent than Comparative Example 4 by the conventional method in the product strength (strength after curing), the good product rate of compacting, and the magnetic permeability.

### Fourth Embodiment

As the fourth embodiment of the present invention, Samples 14 to 19 corresponding to Examples 10, 11 and 12 and Comparative Examples 5, 6 and 7 respectively shown in Table 5 were manufactured. Each of Samples 14 to 19 was manufactured with the conditions shown in Table 5.

Using amorphous alloy powder having a rough composition of (Fe_{0.94}Cr_{0.04})₇₆(Si_{0.5}B_{0.5})₂₂C₂, which was obtained by water atomization method, Fe, 6.5% Si and 1% Cr alloy powder and Fe, 3.5% Si and 5% Cr alloy powder, 0.04 by the mass ratio of the first binder in the composition of silicone resin/organic resin=1/1 was added to the magnetic powder, and Samples 15, 17 and 19 of Examples 10, 11 and 12 were experimentally manufactured by the steps of the present invention in the same manner as in the above-mentioned first embodiment, and evaluations thereof were performed. Furthermore, Samples 14, 16 and 18 of Comparative Examples 5, 6 and 7 were respectively experimentally manufactured using the same soft magnetic metal powder by the conventional method, and evaluated. The results are shown in Table 5.

TABLE 5

| | Sample No. | | | | | |
|---|---|---|---|---|---|---|
| | 14 | 15 | 16 | 17 | 18 | 19 |
| | Classification | | | | | |
| | Comparative | Example | Comparative | Example | Comparative | Example |
| | Example 5 | 10 | Example 6 | 11 | Example 7 | 12 |
| Magnetic powder | Amorphous powder | | Fe—6.5%Si—1%Cr | | Fe—3.5%Si—5%Cr | |
| Content, rate of organic | 0 | 50 | 0 | 50 | 0 | 50 |
| resin in first binder | | | | | | |
| (% by mass) | | | | | | |
| Compacting velocity | 4 | 12 | 6 | 14 | 7 | 15 |
| (piece/minute) | | | | | | |
| Good product rate (%) | 60 | 100 | 80 | 100 | 78 | 100 |
| Specific magnetic | 55 | 65 | 60 | 63 | 58 | 72 |
| permeability | | | | | | |
| Strength after heat | 10 | 8 | 13 | 9 | 15 | 8 |
| treatment and before | | | | | | |
| impregnation (MN/m²) | | | | | | |
| Strength after impregnation | 13 | 14 | 17 | 21 | 19 | 29 |
| and before curing (MN/m²) | | | | | | |
| Strength after curing | 16 | 20 | 20 | 31 | 25 | 37 |
| (MN/m²) | | | | | | |

It was found that in the soft magnetic metal powders shown in Table 5, the strength was inferior in comparison with those used in the fourth embodiment, but the samples manufactured on the basis of the present invention had remarkable improvement of the compacting velocity, and further excellent product strength (strength after curing).

### Fifth Embodiment

As the fifth embodiment of the present invention, Samples 20 to 24 corresponding to Examples 13 to 17 shown in Table 6 were manufactured respectively. Each of Samples 20 to 24 was manufactured with the conditions shown in Table 6.

In Examples 13 to 15, various organic resins soluble to an organic solvent were used with use of the Fe—Si—Al alloy powder indicated in the above-mentioned first embodiment, and the mass ratio of this solvent-soluble organic resin and the silicone resin was 1:1, and the addition amount of the first binder was 0.04 by the mass ratio to the magnetic powder. In addition, as for Example 16, 0.02 by the mass ratio of the silicone resin was added to the same above-mentioned alloy powder, and the mixture was mixed and dried. Then, 0.02 by the mass ratio of a water-soluble acrylic binder was added to the alloy powder, and the mixture was mixed, and then dried and granulated, to obtain mixed powders. Furthermore, as for Example 17, 0.02 by the mass ratio of the silicone resin was added to the same above-mentioned alloy powder, and the obtained magnetic powders were mixed with 0.02 by the mass ratio of paraffin, and the mixture was heated and mixed at 80° C., and then cooled while granulated, to obtain mixed powders. The mixed powders were compacted in the same manner as in the above-mentioned first embodiment, and the strength after the heat treatment and before the impregnation, and the strength after impregnation of the epoxy resin as the second binder, and further the strength after heat-curing at 150° C. for 30 minutes, were evaluated. The results are shown in Table 6.

TABLE 6

| | Sample No. | | | | |
|---|---|---|---|---|---|
| | 20 | 21 | 22 | 23 | 24 |
| | Classification | | | | |
| | Example | Example | Example | Example | Example |
| | 13 | 14 | 15 | 16 | 17 |
| Kind of organic resin in first binder | PVB | MC | PVA | AC | Paraffin |
| Compacting velocity (piece/minute) | 17 | 16 | 15 | 17 | 13 |
| Good product rate (%) | 100 | 100 | 100 | 100 | 100 |
| Specific magnetic permeability | 108 | 103 | 104 | 100 | 99 |
| Strength after heat treatment and | 19 | 18 | 18 | 19 | 19 |
| before impregnation (MN/m²) | | | | | |
| Strength after impregnation and | 53 | 54 | 48 | 50 | 48 |
| before curing (MN/m²) | | | | | |
| Strength after curing (MN/m²) | 79 | 78 | 72 | 75 | 73 |

Remark: PVB; Polyvinyl butyral, MC; Methyl cellulose, PVA; Polyvinyl alcohol, AC; Water-soluble acrylic binder

With reference to Comparative Example 4 in Table 4 and Comparative Examples 5, 6 and 7 in Table 5 together, any one of the first binders allowed high compacting velocity and high good product rate, and excellent specific magnetic permeability and product strength (strength after curing) in Examples 13 to 17.

### Sixth Embodiment

As the sixth embodiment of the present invention, Samples 25 to 29 corresponding to Examples 18 to 22 shown in Table 7 were manufactured respectively. Each of Samples 25 to 29 was manufactured in the manner below.

In the same manner as in the above-mentioned Examples, 0.04 by the mass ratio of the first binder that is a binder having a blend of a silicone resin and an acrylic binder in the mass ratio of 1:1, was added to the alloy powder, and the mixture was mixed, dried and granulated to obtain blended powders. This powder was compacted, heat-treated, and then, impregnated with various resins shown in Table 7 as the second binder, further heat-curing treated (curing) and then the strength was measured in the same manner as in the First Embodiment. The results are shown in Table 7.

TABLE 7

| | Sample No. | | | | |
|---|---|---|---|---|---|
| | 25 | 26 | 27 | 28 | 29 |
| | Classification | | | | |
| | Example | Example | Example | Example | Example |
| | 18 | 19 | 20 | 21 | 22 |
| Second binder | EP | SL | AC | UR | PH |
| Curing condition | 150° C. × | 150° C. × | 120° C. × | 80° C. × | 90° C. × |
| | 30 minutes | 30 minutes | 30 minutes | 15 minutes | 15 minutes |
| Strength before | 55 | 40 | 43 | 39 | 40 |
| curing (MN/m²) | | | | | |
| Strength after | 75 | 73 | 56 | 60 | 54 |
| curing (MN/m²) | | | | | |

Remark: EP; Epoxy resin, SL; Silicone resin, AC; Acrylic resin, UR; Urethane resin, PH; Phenol resin

It was found that the strength improved by heat-curing treatment for any impregnation resin (the second binder) in Examples 18 to 22.

### Seventh Embodiment

the seventh embodiment of the present invention, Samples 30, 31 and 32 corresponding to Examples 23, 24 and 25 shown in Table 8 were manufactured respectively. Using a compact manufactured with the same conditions of Sample 10 in Table 4, each of Samples 30, 31 and 32 was impregnated with an epoxy resin as the second binder, and then heat-curing treated with conditions shown in Table 8.

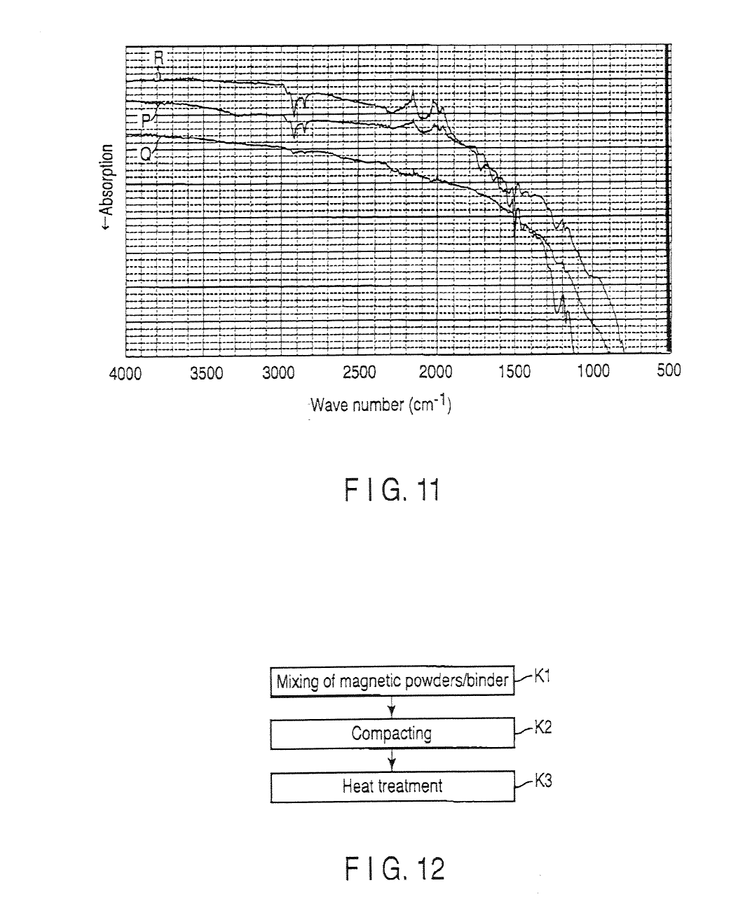

Using Sample 33 that was not heat-cured as Comparative Example 8, strength measurement and infrared spectroscopy analysis test were conducted. This Sample 33 of Comparative Example 8 is substantially equal to Sample 10 in Table 4. The results are shown in. Table 8 and FIG. 11. FIG. 11 is a diagrammatic property view showing results of an infrared spectroscopy analysis test of various samples, wherein the horizontal axis represents wavelength (cm−1) for measurement, and the vertical axis represents light absorption strength (relative value). In FIG. 11, the property line P shows the results of Sample 31 (Example 24) that was heat-treated at 200° C. for 30 minutes, the property line Q shows the results of Sample 32 (Example 25) that was heat-treated at 300° C. for 30 minutes and the property line R shows results of Sample 33 (Comparative Example 8) that was not heat-treated, respectively.

TABLE 8

| | Sample No. | | | |
|---|---|---|---|---|
| | 30 | 31 | 32 | 33 |
| | Classification | | | |
| | Example | Example | Example | Comparative |
| | 23 | 24 | 25 | Example 8 |
| Strength before | — | — | — | 48 |
| curing | | | | |
| (MN/m²) | | | | |
| Curing | 150° C. × | 200° C. × | 300° C. × | — |
| condition | 30 minutes | 30 minutes | 30 minutes | |
| Strength after | 75 | 78 | 43 | — |
| curing | | | | |
| (MN/m²) | | | | |

As shown in Table 8, the strength increases as curing temperature increases, but the strength decreases reversely at a temperature more than a certain temperature (for example, 250° C.). In FIG. 11, the property line Q shows the results of the infrared spectroscopy analysis for Sample 32 (Example 25), which was heat-curing treated at a temperature more deterioration temperature, the property line P shows the results of the infrared spectroscopy analysis for Sample 3. (Example 24), which was heat-treated at lower temperature, and the property line R shows the results of the infrared spectroscopy analysis for untreated Sample 33 (Comparative Example 3), which was not heat-curing treated. As shown in FIG. 11, the property line Q was recognized to have nearly no peak, whereas the property lines P and R were recognized to have many peaks. It was found from this that Sample 31 (Example 24), which was heat-treated at lower temperature, secured the strength by the molecular structure of the impregnated material maintaining the original shape.

### Eighth Embodiment

As the eighth embodiment of the present invention, Samples 34 to 36 and 12 corresponding to Examples 26, 27, 29, 29 and 9 and Comparative Example 9 shown in Table 9 were manufactured respectively. Each of Samples was manufactured with the conditions shown in Table 9.

Using the soft magnetic metal powder used in the above-mentioned third embodiment, ceramics (water glass) and polyvinyl alcohol were used as the first binder and mixed in various ratios, and 0.04 by the mass ratio of the first binder was blended to the magnetic powder, and the mixture was wet-mixed using water as a dispersion solvent, and then dried and granulated to manufacture mixed powders, and tests were conducted in the same manner as in the third embodiment.

As Comparative Example 9, 0.04 by the mass ratio of ceramics (water glass) was added to the magnetic powder, to manufacture Sample 34, and the same tests were conducted. The results are shown in Table 9. Furthermore, using an epoxy resin as the second binder (impregnation resin), curing treatment at 150° C. for 30 minutes was added.

TABLE 9

| | Sample No. | | | | | |
|---|---|---|---|---|---|---|
| | 34 | 35 | 36 | 37 | 38 | 12 |
| | Classification | | | | | |
| | Comparative | Example | Example | Example | Example | Example |
| | Example 9 | 26 | 27 | 28 | 29 | 9 |
| Content rate of organic resin | 0 | 10 | 30 | 50 | 70 | 100 |
| in first, binder (% by mass) | | | | | | |
| Compacting velocity | 3 | 3 | 5 | 8 | 8 | 17 |
| (piece/minute) | | | | | | |
| Good product rate (%) | 40 | 40 | 75 | 85 | 100 | 100 |
| Specific magnetic permeability | 67 | 71 | 75 | 77 | 77 | 105 |
| Strength before curing (MN/m²) | 46 | 55 | 52 | 48 | 39 | 21 |
| Strength after curing (MN/m²) | 53 | 76 | 73 | 78 | 65 | 54 |

When a water glass is used as the first binder, the compacting velocity becomes slow in comparison with the case where a silicone resin is used in the third embodiment. However, application of the method of the present invention allows speed up by nearly triple times of the compacting velocity. Furthermore, it was found that the sample manufactured on the basis of the present invention had excellent product strength strength after curing) similarly to the sample using the silicone resin as the first binder.

### Ninth Embodiment

As the ninth embodiment of the present invention, Samples 40, 42, 39 and 41 corresponding respectively to Examples 30 and 31 and Comparative Examples 10 an shown in Table 10, were manufactured respectively. Each of Samples 39 to 42 was manufactured with the conditions shown in Table 10.

Using the ceramic powder as the first binder of Example 30, a mixture of the ceramic powder with polyvinyl butyral (PVB) was applied and subjected to a wet process by methylethyl ketone, to manufacture mixed powders. In addition, as for Example 31, ceramic powders and polyvinyl alcohol (PVA) were dissolved in water, and mixed powders were manufactured in the same manner, and tests were conducted in the same manner as in the sixth embodiment. In addition, as for Comparative Examples 10 and 11, Samples 39 and 41 were used, in which ceramic powder was added in 0.04 by the mass ratio to the alloy powder. The results are shown in Table 10. Furthermore, using an epoxy resin as the second binder, curing treatment at 150° C. for 30 minutes was added.

TABLE 10

| | Sample No. | | | |
|---|---|---|---|---|
| | 39 | 40 | 41 | 42 |
| | Classification | | | |
| | Comparative | Example | Comparative | Example |
| | Example 10 | 30 | Example 11 | 31 |
| First Binder | Frit/PVB | | Frit/PVA | |
| Content rate of organic resin | 0 | 50 | 0 | 50 |
| in first binder (% by mass) | | | | |
| Compacting velocity (piece/minute) | 2 | 7 | 3 | 7 |
| Good product rate (%) | 20 | 50 | 20 | 50 |
| Specific magnetic permeability | 60 | 77 | 60 | 73 |
| Strength before curing (MN/m²) | 33 | 30 | 35 | 29 |
| Strength after curing (MN/m²) | 45 | 60 | 46 | 55 |

When the ceramic powders are used, the mixed powders have poor flowability, and are difficult in automatic supply of the powder to the die gap, and have nearly no mass production property. According to the method of the present invention, the mass production can be somewhat higher than the current situation.

### Tenth Embodiment

### Examples 32 to 37

In the present Examples 32 to 37, amorphous soft magnetic metal powder having a rough composition of (Fe_{0.54}Cr_{0.04})₇₆(Si_{0.5}B_{0.5})₂₂C₂ was obtained by water atomization method as the soft magnetic alloy powder, although the Fe alloy having a rough composition of 9.6% Si and 5.5% Al obtained by the vacuum dissolution method was used so far. These metal powders were mechanically mixed with 0.01 by the mass ratio of polyvinyl butyral and 0.01 by the mass of a silicone resin as the first binder, and then the mixture was heated while stirred, and dried and granulated. Thus-obtained granulated bodies were added with 0.01 by the mass ratio of stearic acid, and a predetermined amount was weighed, and die-compacted under 1.96 GPa of the pressure, to manufacture a toroidal sample having 21 mm of the outer diameter, 17 mm of the inner diameter and 4 mm of the thickness. The present compact was heat-treated at 450° C. for 1 hour. The Sample 43 was taken as Example 32. A sample that was heat-treated at the same conditions was further impregnated with an epoxy resin as the second binder. As for the impregnation conditions, the epoxy resin was diluted with same amount of acetone, put into a vacuum desiccator, and the sample was further immersed in the epoxy solution, and vacuum-treated to 0.01 MPa or so, which was maintained for about 10 minutes, and then recovered to atmospheric pressure. Furthermore, heat-curing treatment at various temperatures for 1 hour was performed, to obtain samples for measurement. These samples were taken as Examples 33 to 37.

### (Measurement Method For Magnetic Property)

Magnetic permeabilities of Examples 32 to 37 were measured respectively at a condition of 10 kHz frequency using a LCR meter (HP 4284A).

In addition, core losses of Examples 32 to 37 were measured respectively at conditions of 100 kHz frequency and 100 mT applied magnetic field using an iron loss measurement system (Iwatsu SY-8617).

The evaluation results are shown in Table 11.

TABLE 11

| | | Heat-curing | Magnetic | Core loss | Core strength |
|---|---|---|---|---|---|
| Classification | Sample No. | temperature (° C.) | permeability | (kW/m³) | (MN/m²) |
| Example 32 | 43 | No impregnation | 81 | 400 | 4.8 |
| Example 33 | 44 | — | 80 | 380 | 8.0 |
| Example 34 | 45 | 150 | 78 | 400 | 20.0 |
| Example 35 | 46 | 250 | 76 | 470 | 25.0 |
| Example 36 | 47 | 350 | 77 | 440 | 10.0 |
| Example 37 | 48 | 450 | 70 | 450 | 7.7 |

It is found that when the impregnation methods described in Table 11 were used, a balance of the magnetic property with the core strength is achieved, and the strength also reaches actual use level. In addition, in view of the core strength with increase of the heat-curing temperature in Table 11, the core strength of Sample 46 that is treated at 250° C., is the maximum, 25 MN/m2 (Example 35), and the core strengths of Samples 47 and 48 that are treated at higher temperature than 250° C., decrease (Examples 36 and 37). The cause for this is presumed from the heat analysis results to be transformation, i.e., degradation of the molecular structure of the epoxy resin.

### Comparative Examples 12 to 18

Using the same magnetic powder as those of the tenth embodiment, a silicone resin as the first binder was mechanically mixed in 0.02 by the mass ratio, and then, a compact was obtained in the method as described above. The present compact was heat-treated at various temperatures for 1 hour in the nitrogen airflow, to obtain 7 kinds of samples. These samples were taken as Comparative Examples 12 to 18.

The evaluation results are shown in Table 12.

TABLE 12

| | Sample | Heat-treatment | Magnetic | Core loss | Core strength |
|---|---|---|---|---|---|
| Classification | No. | temperature (° C.) | permeability | (kW/m³) | (MN/m²) |
| Comparative | 49 | No heat-treatment | 30 | 4500 | 1.5 |
| Example 12 | | | | | |
| Comparative | 50 | 300 | 40 | 4000 | 3.0 |
| Example 13 | | | | | |
| Comparative | 51 | 400 | 45 | 1000 | 3.5 |
| Example 14 | | | | | |
| Comparative | 52 | 450 | 60 | 600 | 4.0 |
| Example 15 | | | | | |
| Comparative | 53 | 500 | 60 | 2200 | 6.2 |
| Example 16 | | | | | |
| Comparative | 54 | 550 | 45 | 3000 | 11.0 |
| Example 17 | | | | | |
| Comparative | 55 | 650 | — | — | 20.0 |
| Example 18 | | | | | |

From Table 12, as the heat treatment temperature increases, the magnetic permeability increases and the core loss decreases, whereby to improve magnetic property, and increase core strength. However, even for Comparative Example 15, which has lowest core loss, the core strength is not in the actual use level. Although the strength can be improved by a heat treatment at high temperature as seen in Comparative Examples 17 and 18, the magnetic properties are deteriorated due to crystallization of the amorphous, and thus this cannot be provided to actual use as well.

### Comparative Examples 1 to 23

Mixed powders were manufactured with change of the amount of the silicone resin, and a compact was obtained in the same manner, and heat-treated at temperature 450° C., and provided to measurements. These samples were taken as Comparative Examples 19 to 23. The results are shown in Table 13.

TABLE 13

| | Sample | Addition amount | Magnetic | Core loss | Core strength |
|---|---|---|---|---|---|
| Classification | No. | of silicone resin | permeability | (kW/m³) | (MN/m²) |
| Comparative | 56 | 0.025 | 52 | 800 | 7.6 |
| Example 19 | | | | | |
| Comparative | 57 | 0.03 | 40 | 950 | 9.5 |
| Example 20 | | | | | |
| Comparative | 58 | 0.035 | 32 | 1300 | 15.0 |
| Example 21 | | | | | |
| Comparative | 59 | 0.015 | 66 | 450 | 3.6 |
| Example 22 | | | | | |
| Comparative | 60 | 0.010 | 77 | 450 | 3.5 |
| Example 23 | | | | | |

From Table 13, if the addition amount of the resin increases, the core strength improves but the magnetic property is deteriorated. Reversely, if the resin amount decreases, the magnetic property improves, but the core strength is not in the actual use level.

From the results of the above-mentioned Table 12 and Table 13, it is found that a dust core manufactured by a conventional manufacturing method using amorphous soft magnetic metal powders is difficult to provide to actual use.

### Eleventh Embodiment

Using the same magnetic powder as these of the tenth embodiment, the first binder (the compacting additive) was studied in various ways when the impregnation method was used as a method for manufacturing a dust core. As for Samples 62, 63, 54 and 65, the ratio of the silicone resin amount (shown as Silicone in the Table) to polyvinyl butyral (PVB) was variously changed in a variety to 1:0, 0.75:0.25, 0.25:0.75 and 0:1, and they were blended in 0.02 of the sum addition amount of the two to the amount of the magnetic powders, and the mixture was mixed, dried and granulated, and then compacted under 1.96 GPa of the pressure, and then heat-treated at 450° C. temperature for 1 hour in the nitrogen atmosphere, impregnated with an epoxy resin, and then heat-cured to 150° C., to obtain Examples 38 to 41. Various properties of Examples 38 to 41 are shown in Table 14.

As shown clearly, Sample 45 (Example 34) in which the ratio of the silicone resin to PVB is 0.5:0.5, was also described in Table 14. In addition, Sample 61 as Comparative Example 24, which was not impregnated with the second binder, was also described in Table 14.

In addition, 0.01 by the mass ratio of a silicone resin and 0.01 by the mass ratio of an acrylic-based binder (OA) were added in a ratio of 0.5:0.5 to the magnetic powder, and Sample 66 was prepared by the same steps as described above, which was taken as Example 42.

Next, Sample 57 was prepared in the same method as described in Sample 66 except that paraffin wax (PA) having about 60° C. melting point was heat-mixed instead the acrylic-based binder, which was taken as Example 43. In addition, 0.01 by the ma of silicone was mixed with the magnetic powder, and mixture was dried, and then 0.01 polyvinyl alcohol (PVA) was added thereto, and Sample 63 was manufactured in the same manner, which was taken as Example 44. In addition, 0.01 by the mass ratio of silicone was mixed with the magnetic powder, and the mixture was dried, and then 0.01 water-based acrylic binder (WA) was used to prepare Sample 69, which was taken as Example 45. Evaluation results of these Examples 34 and 38 to 45 and Comparative Example 24 are shown in Table 14.

TABLE 14

| | Sample | Composition ratio | Magnetic | Core loss | Core strength |
|---|---|---|---|---|---|
| Classification | No. | of first binder | permeability | (kW/m³) | (MN/m²) |
| Comparative | 61 | Silicone/PVB = 0.5/0.5 | 81 | 400 | 4.8 |
| Example 24 | | | | | |
| Example 38 | 62 | Silicone/PVB = 1/0 | 60 | 600 | 23.0 |
| Example 39 | 63 | Silicone/PVB = 0.75/0.25 | 70 | 470 | 19.0 |
| Example 34 | 45 | Silicone/PVB = 0.5/0.5 | 78 | 400 | 20.0 |
| Example 40 | 64 | Silicone/PVB = 0.25/0.75 | 80 | 370 | 18.0 |
| Example 41 | 65 | Silicone/PVB = 0/1 | 80 | 380 | 16.0 |
| Example 42 | 66 | Silicone/OA = 0.5/0.5 | 76 | 470 | 24.0 |
| Example 43 | 67 | Silicone/PA = 0.5/0.5 | 77 | 390 | 16.0 |
| Example 44 | 68 | Silicone/PVA = 0.5/0.5 | 74 | 460 | 29.0 |
| Example 45 | 69 | Silicone/WA = 0.5/0.5 | 72 | 490 | 16.0 |

Remark:
Silicone = Silicone resin,
PVB = Polyvinyl butyral,
OA = Organic solvent-soluble acrylic binder,
PA = Paraffin wax,
PVA = Polyvinyl alcohol,
WA = Water-soluble acrylic binder

As shown in Table 14, it was found that any one the various properties of Examples 34 and 36 to 45 was excellent in comparison with those of Comparative Example 24.

### Twelfth Embodiment

Using the same magnetic powders as those of the eleventh embodiment and using a silicone resin and PVB as the first binder, the silicone resin and PVB in a ratio of 0.25:0.75 were blended in 0.02 of the sum addition amount of the two to the amount of the magnetic powders, and the mixture was mixed, dried and granulated, and then compacted under 1.96 Ga of the pressure, and then heat-treated at 450° C. temperature for 1 hour in atmosphere of hydrogen, argon, air, or 0.01 MPa or less of vacuum atmosphere, impregnated with an epoxy resin, and then heat-cured to 150° C. for 30 minutes to prepare Samples 70 to 73 (Examples 45 to 49). Various properties of Samples 70 to 73 (Examples 45 to 49) are shown in Table 15.

TABLE 15

| | | Heat treatment | Magnetic | Core loss | Core strength |
|---|---|---|---|---|---|
| Classification | Sample No. | atmosphere | permeability | (kW/m³) | (MN/m²) |
| Example 46 | 70 | Hydrogen | 81 | 360 | 18.0 |
| Example 47 | 71 | Argon | 78 | 360 | 19.0 |
| Example 48 | 72 | Air | 68 | 590 | 20.0 |
| Example 49 | 73 | Vacuum | 80 | 370 | 18.0 |

From the results of Table 15, it was found that any one of the properties was more excellent than those by the conventional method, and particularly non-oxidation atmosphere allowed the general level up of the various properties.

### Thirteenth Embodiment

Using the same magnetic powders as those of the eleventh embodiment end using a silicone resin and PVB as the first binder, the silicone resin and PVB in a ratio of 0.25:0.75 were blended in 0.02 of the sum addition amount of the two to the amount of the magnetic powder, and the mixture was mixed, dried and granulated, and then compacted under 1.96 GPa of the pressure. Then, the compact was heat-treated a: 450° C. temperature for 1 hour in nitrogen atmosphere, and impregnated with each of the selected materials as the second binder, i.e., an epoxy resin, an acrylic resin, a phenol resin, a melamine resin, a vinyl resin bond, silicone resin, and a water glass at preferred conditions, and heat-curing treated to prepare Samples 74 to 82 (Examples 50 to 58). Various properties of Samples 74 to 82 (Examples 50 to 58) are shown in Table 16. When multiple kinds were tried such as in the epoxy resin and the silicone resin, the differences of the properties were classified with pencil hardness.

TABLE 16

| | | Second binder | | | |
|---|---|---|---|---|---|
| | Sample | (pencil hardness of | Magnetic | Core loss | Core strength |
| Classification | No. | impregnation material) | permeability | (kW/m³) | (MN/m²) |
| Example 50 | 74 | Epoxy resin (1B) | 81 | 420 | 21.0 |
| Example 51 | 75 | Epoxy resin (6B) | 79 | 360 | 13.0 |
| Example 52 | 76 | Acrylic resin | 77 | 430 | 12.0 |
| Example 53 | 77 | Phenol resin | 77 | 460 | 23.0 |
| Example 54 | 78 | Melamine resin | 78 | 470 | 28.0 |
| Example 55 | 79 | Vinyl resin bond | 78 | 390 | 14.0 |
| Example 56 | 80 | Silicone resin (1B) | 80 | 450 | 20.0 |
| Example 57 | 81 | Silicone resin (5B) | 81 | 360 | 15.0 |
| Example 58 | 82 | Water glass | 76 | 590 | 18.0 |

From Table 16, it is judged that there is bit of difference depending on the kind of the impregnation resin, which cannot be narrowed at this time, but rather, any resin used as the second binder gives superior properties to those of the conventional method.

### Fourteenth Embodiment

The water atomization, powder was used as amorphous soft magnetic powder in the above-described embodiments. However, in the present embodiment, any one of gas atomization powder, amorphous ribbon pulverization powder, amorphous scrap pulverization powder, and nanocrystalline ribbon pulverization powder was used as amorphous soft magnetic powder.

Namely, as the gas atomization powders, powders having a composition of Fe73Si10B17 were used. In addition, as the amorphous ribbon pulverization powder, powders obtained by pulverization of commercially available Fe—Si—B-based amorphous ribbon to 250 meshes or less, were used. In addition, as the amorphous pulverization powder, powders assumed as amorphous scrap obtained by heat treatment of amorphous ribbon having the same composition as that of amorphous scrap pulverization powders and then pulverization of the same, were used. In addition, as the nanocrystalline ribbon pulverization powder, powders obtained, by pulverizing commercially available material that is called the nanocrystalline ribbon in the same manner, were used. Using the silicon resin and PVB in a ratio of 0.25:0.75 were blended in 0.02 of the sum addition of the two to the amount of the magnetic powder, and the mixture was mixed, dried and granulated, and then compacted under 1.96 GPa of the pressure, and then heat-treated at conditions preferred for each of the materials, impregnated with an epoxy resin as the second binder, and then heat-cured to 150° C. for 1 hour, and various properties were measured. In addition, as for Comparative Examples 25, 26, 27 and 28, Samples 84, 86, 88 and 90 were prepared using these magnetic powders a method comprising no impregnation with the second binder, and various properties thereof were also measured. The results are shown in Table 17.

TABLE 17

| | Sample | Kind of | Magnetic | Core loss | Core strength |
|---|---|---|---|---|---|
| Classification | No. | magnetic powder | permeability | (kW/m³) | (MN/m²) |
| Example 59 | 83 | Gas atomization powder | 82 | 550 | 12.0 |
| Comparative | 84 | Gas atomization powder | 60 | 570 | 3.0 |
| Example 25 | | | | | |
| Example 60 | 85 | Ribbon pulverization | 76 | 440 | 26.0 |
| | | powder | | | |
| Comparative | 86 | Ribbon pulverization | 64 | 610 | 6.0 |
| Example 26 | | powder | | | |
| Example 61 | 87 | Ribbon scrap | 73 | 560 | 28.0 |
| | | pulverization powder | | | |
| Comparative | 88 | Ribbon scrap | 62 | 780 | 8.0 |
| Example 27 | | pulverization powder | | | |
| Example 62 | 89 | Nanocrystalline ribbon | 77 | 540 | 23.0 |
| | | pulverization powder | | | |
| Comparative | 90 | Nanocrystalline ribbon | 61 | 890 | 6.0 |
| Example 28 | | pulverization powder | | | |

From Table 17, it is found that application of the impregnation process by the present invention using any amorphous soft magnetic powder allows excellent various properties and expression of practicality. When the pulverization powder was used, the core strength improves generally as compared to atomized powder. This is presumed to be due to the fact that the shape pulverization powder becomes irregular and mechanical bonds of powder to each other occur. However, the reason why the core strength by the conventional method does not reach the actual use level even with use of such powders is presumed to be due to the fact that amorphous powder is harder than crystalline soft magnetic material powders, difficult to change in shape.

### Fifteenth Embodiment

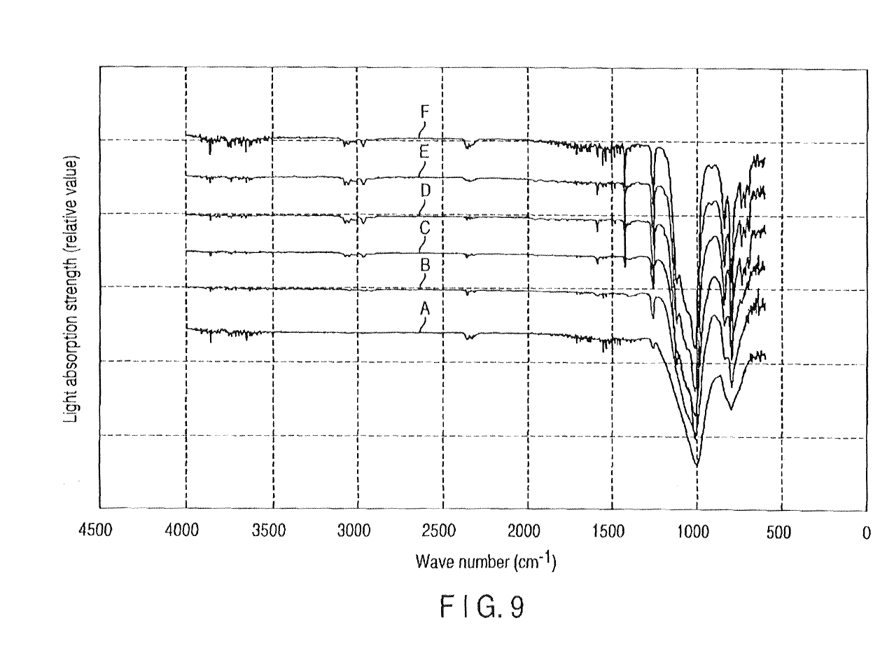

Using the same magnetic powders as those of the tenth embodiment and using a silicone resin and PVB as the first binder, the silicone resin and PVB in a ratio of 0.25:0.75 were blended in 0.02 of the sum addition amount of the two to the amount of the magnetic powder, and the mixture was mixed, dried and granulated, and then compacted under 1.96 GPa of the pressure, and then heat-treated at 450° C. temperature for 1 hour in nitrogen atmosphere, impregnated with a silicone resin as the second binder, and then heat-cured with change of the heat-curing temperature, and magnetic permeability, core loss and core strength were measured respectively. The results are shown in Table 16. In addition, infrared spectroscopy analysis tests were conducted for the silicone resin used in the fifteenth embodiment. The results are shown in FIG. 9. FIG. 9 is a diagrammatic property view showing results of an infrared spectroscopy analysis test of samples obtained with various change of the temperature of the heat treatment, wherein the horizontal axis represents wave number (cm−1) of the light, and the vertical axis resents light absorption strength (relative value). In FIG. 9, the property line A shows the results of the heat treatment at 720° C.; the prop results of the heat treatment at 600° C.; the property line C shows the results of the heat treatment at 50° C.; the property line D shows the results of the heat treatment at 400° C.; and the property line E shows the results of the heat treatment at 200° C., respectively. The property line F shows the results no heat treatment.

TABLE 18

| | | Heat curing | | | |
|---|---|---|---|---|---|
| | Sample | temperature | Magnetic | Core loss | Core strength |
| Classification | No. | (° C.) | permeability | (kW/m³) | (MN/m²) |
| Example 63 | 91 | 150 | 80 | 370 | 18.0 |
| Example 64 | 92 | 250 | 80 | 400 | 25.0 |
| Example 65 | 93 | 350 | 79 | 590 | 30.0 |
| Example 66 | 94 | 550 | 78 | 770 | 35.0 |

As shown in Table 18 and FIG. 9, the core strength increases as the heat-curing temperature after impregnation increases. However, if the heat-curing temperature is too high, the molecular structure of the silicone resin is transformed to decrease the magnetic properties. Among the magnetic properties, the core loss is particularly lowered highly (Examples 65 and 66). In order to maintain the core loss to the actual use level, the heat-curing temperature after impregnation is desirably set to a temperature where the impregnated material is not transformed, or a temperature where transformation of the impregnated material is small.

### Sixteenth Embodiment

To verify the reason why the manufacturing process for a dust core using amorphous soft magnetic metal powder as mentioned above, are effective, which comprises the mixing step of the soft magnetic metal powder and the compacting additive, the compacting step, the heat treatment step, the binder impregnation step and the cure treatment if necessary, experiments described below were tried. Namely, the constitution composite magnetic material using amorphous soft magnetic metal powder, and the constitution of a composite magnetic material using pure iron were investigated respectively using a scanning electronic microscope (SEM).

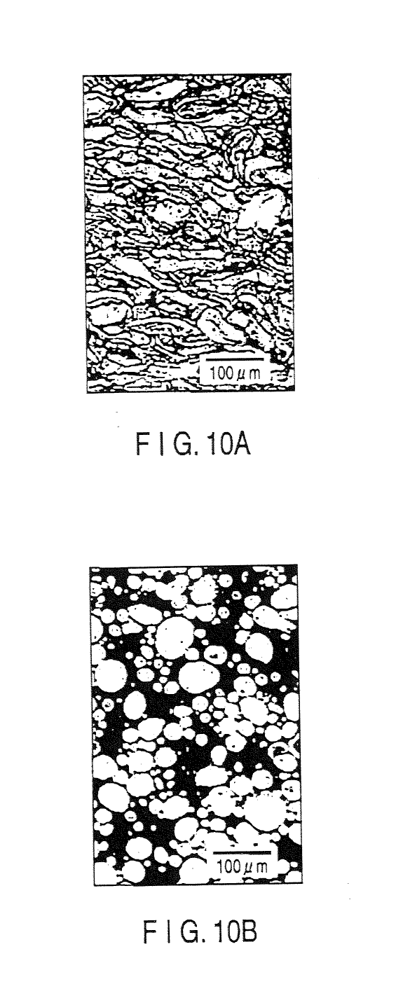

FIG. 10A shows the SEM photograph constitution of the composite magnetic material (dust core) using pure iron powder as a raw material, and FIG. 10B shows the SEM photograph of the constitution of the composite magnetic material (dust core) using the amorphous soft magnetic metal powder as a raw material, respectively.

The pure iron is bonded to each other by change in shape of the powders in the compacting step, whereas the amorphous soft magnetic metal powder is nearly in a spherical form and entanglement of powders to each other after the compacting is not seen. In addition, the hardness of the magnetic material that was used in kind of a composite magnetic vial was investigated, and it was found that the hardness of the amorphous soft magnetic material was remarkably high as shown in Table 19.

TABLE 19
Hardness of various magnetic material

| | Vickers hardness |
|---|---|
| Material | Hv |
| Pure iron (Fe) | 80 |
| (Fe_{0.94}Cr_{0.04})₇₆(Si_{0.5}B_{0.5})₂₂C₂ | 900 |
| Fe—Ni | 120 |
| Fe—9.6% Si—5.5% Al | 500 |

From these results, the reason why a composite magnetic material manufactured using amorphous soft magnetic metal powders by the conventional method does not reach the actual use level, was revealed that the powder shape has a spherical form and further is hard and difficult to change in shape. Namely, it was found that a mutual bond of the amorphous soft magnetic metal powders is inhibited in the compacting step of the conventional method, and as a result, mechanical strength of a product decreases.

The present invention can be used for an inductor that is wire-wound to a metal-based soft magnetic alloy composite material that is applied to an electronic circuit such as a power circuit.

What is claimed is:

1. A composite magnetic material for an inductor, in which a soft magnetic metal powder is bonded with a non-magnetic material, wherein
the non-magnetic material comprises a first binder comprising an organic resin which is added to and mixed with the soft magnetic metal powder, as a compacting additive, and a second binder that is impregnated into a compact, which is obtained by compacting the soft magnetic metal powder added with the first binder as a binder, after heat treatment of the compact, and is heat-cured; the organic resin comprises one or two or more selected from the group consisting of polyvinyl butyral (PVB), polyvinyl alcohol (PVA), methyl cellulose (MC), water-soluble acrylic binder (AC), paraffin, glycerin and polyethylene glycol, and has granulatability, compactibility, shape retainability and thermal decomposability, and
the soft magnetic metal powder contains 40% by the so mass or more (including 100%) of spherical particles which the ratio L₂/L₁ between a perimeter L₁ of a particle cross-section in the two dimensional plane view and a perimeter L₂ of a circle having equivalent cross-sectional area is 0.5 or more.

2. The composite magnetic material according to claim 1, wherein the soft magnetic metal powder contains amorphous particles obtained using a water atomization method or a gas atomization method.

3. The composite magnetic material according claim 1, wherein the soft magnetic metal powder contains amorphous particles obtained by mechanical pulverization of a ribbon or lump amorphous material.

4. The composite magnetic material according to claim 1, wherein the soft magnetic metal powder consists of microcrystalline particles obtained using a water atomization method or a gas atomization method, or microcrystalline particles obtained by mechanical pulverization of ribbon or lump amorphous material.

5. The composite magnetic material according to claim 1, wherein the soft magnetic metal powder consists of crystalline particles obtained by mechanical pulverization of a lump alloy.

6. The composite magnetic material according to claim 5, wherein the crystalline particle contains 3% by mass or more and 10% by mass or less of Si, and the balance consisting of Fe and inevitable impurities.

7. The composite magnetic material according claim 6, wherein the crystalline particle further contains 6% by mass or less excluding 0%) of Al, and the balance consisting of Fe, Si and inevitable impurities.

8. A method of producing a composite magnetic material for an inductor, in which a soft magnetic metal powder is bonded with a non-magnetic material, comprising:
(a) preparing a soft magnetic metal powder that contains 40% by mass or more (including 100%) of spherical particles of which the ratio L₂/L₁ between perimeter L₁ of a particle cross-section in the two dimensional plane view and a perimeter L₂ of a circle having equivalent cross-sectional area is 0.5 or more, and mixing the soft magnetic metal powder with first binder as a compacting additive in a predetermined ratio, comprising one or two or more organic resins selected from the group consisting of polyvinyl butyral (PVB), polyvinyl alcohol (PVA), methyl cellulose (MC), water-soluble acrylic binder (AC), paraffin, glycerin and polyethylene glycol, wherein the organic resin has granulatability, compactibility, shape retainability and thermal degradability;
(b) compacting the mixture obtained in step (a) into a desired shape;
(c) heat-treating the compact obtained in step (b) under predetermined conditions, and heat-degrading the organic resin to form voids between the particles of the soft magnetic metal powder; and
(d) impregnating the compact after the heat treatment with a second binder comprising one or two or more selected from the group consisting of a silicone resin, an organic resin and a water glass under predetermined conditions, whereby filling the voids formed in step (c) with the second binder, and then heating the compact to cure the second binder.

9. The method according to claim 8, wherein the first binder comprises the organic resin and the silicone resin that are thermally decomposed in step (c) and comprises 20% by mass or more and 100% or less (including 100%) of the organic resin and 80% by mass or less (including 0%) of the silicone resin.

10. The method according to claim 8, wherein the first binder comprises the organic resin that is thermally decomposed in step (c) and a ceramic comprises 30% by mass or more and 100% or less (including 100%) of the organic resin and 70% by mass or less (including 0%) of the ceramic.

11. The method according to claim 8, wherein in step (a), the first binder, which is soluble in an organic solvent or water, the soft magnetic metal powder are weighed respectively, and the two are wet-mixed, and then dried and granulated.

12. The method according to claim 8, wherein in step (a), a silicone resin and the soft magnetic metal powder are weighed respectively, and the two are wet-mixed, dried, and then a water-soluble organic resin as the organic resin is weighed, the weighed water-soluble organic resin is wet-mixed with mixed powders of the soft magnetic metal powder and the silicone resin, then dried and granulated.

13. The method according to claim 8, wherein in step (a), a silicone resin and the soft magnetic metal powder are weighed respectively, and the two are wet-mixed, dried, and then a thermoplastic resin as the organic resin is weighed, and the weighed thermoplastic resin is heat-mixed with mixed powders of the sort magnetic metal powder and the silicone resin, and granulated.

14. The method according to claim 8, wherein in step (a), a ceramic and the soft magnetic metal powder are weighed respectively, wet-mixed using water as a dispersion media, dried, and the mixture is further wet-mixed with the organic resin, which is soluble in an organic solvent, dried and granulated.

15. The method according to claim 8, wherein in step (a), a ceramic and the soft magnetic metal powder are weigh respectively, and wet-mixed using water as a dispersion media, dried, and then a thermoplastic resin as the organic resin is weighed, and the weighed thermoplastic resin is neat-mixed with mixed powders of the soft magnetic metal powder and the ceramic, and granulated.

16. The method according to claim 8, wherein in step (c), a temperature of the heat treatment is equal to or less than the crystallization temperature of the amorphous particles.

17. The method according to claim 8, wherein in step (c), an atmosphere in the heat treatment is non-oxidative atmosphere.

18. The method according to claim 8, wherein the second binder has a molecular structure of a single substance.

19. The method according to claim 5, wherein in step (d), the compact is placed under an atmosphere of reduced pressure that is a lower pressure than atmospheric pressure, and the compact is vacuum-impregnated with the second binder.

20. The method according to claim 8, wherein in step (d), the compact is placed under an atmosphere of atmospheric pressure, or pressurized atmosphere that is a higher pressure than atmospheric pressure, and the compact is impregnated with the second binder.
